(19) United States
(12) Patent Application Publication
(10) Pub. No.: US 2024/0385156 A1
(43) Pub. Date: Nov. 21, 2024

(54) METHODS AND SYSTEMS FOR ANALYSIS OF MASS SPECTROMETRY DATA

(71) Applicant: Seer, Inc., Redwood City, CA (US)

(72) Inventors: Biao LI, Foster City, CA (US); Ryan BENZ, Huntington Beach, CA (US); Harendra GUTURU, Oakland, CA (US); Iman MOHTASHEMI, Mountain House, CA (US); Theodore PLATT, Pleasanton, CA (US); Serafim BATZOGLOU, San Francisco, CA (US)

(21) Appl. No.: 18/318,563

(22) Filed: May 16, 2023

(51) Int. Cl. G01N 30/86; G01N 30/72; G01N 30/88; G06N 3/08

(52) U.S. Cl. CPC G01N 30/8696; G01N 30/7206; G01N 30/88; G06N 3/08; G01N 2030/8813

(57) ABSTRACT

The present disclosure describes methods and systems for analyzing mass spectrometry data. The methods and systems can comprise an operation of contacting a plurality of biomolecules with a plurality of surfaces. The methods and systems can further comprise performing mass spectrometry on the plurality of biomolecules, or a portion or derivative thereof. The methods and systems can further comprise classifying a sample based on the mass spectra. The methods and systems of the disclosure may be used for identifying evidence of operational errors in mass spectrometry datasets.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND

Biological samples contain a wide variety of proteins and nucleic acids. Computational methods are needed for elucidating the presence and concentration of proteins and nucleic acids as well as any correlations between proteins and nucleic acids that may be indicative of a biological state.

### SUMMARY

An aspect of the present disclosure provides a neural network for identifying potential operational errors in mass spectrometry measurements, comprising: a first layer that receives a mass spectrum; and a second layer, in operable communication with the first layer, that outputs a classification for an experimental parameter, among a plurality of measurement types, that was used to generate the mass spectrum.

In some embodiments, the neural network is pre-trained. In some embodiments, the neural network comprises one or more of VGG-19, ResNet, Inception, MobileNet, and EfficientNet. In some embodiments, the experimental parameter comprises a surface type, a sample type, a liquid chromatography (LC) column type, an LC system pressure, a mass ionizer type, a buffer type, a pH, a temperature, a contamination, a subject characteristic, or any combination thereof. In some embodiments, the mass spectrum is generated from at least a part of a biological sample, and wherein the subject characteristic comprises a characteristic associated with a subject from which the sample is derived. In some embodiments, the subject characteristic comprises age, gender, race, ethnicity, medical history, current or previous disease state, current or previous health status, risk of disease state, current or previous therapeutic intervention, or any combination thereof. In some embodiments, the surface type comprises a particle type. In some embodiments, the particle type comprises or is associated with one or more physicochemical properties. In some embodiments, the one or more physicochemical properties comprise size, surface charge, zeta potential, hydrophobicity, hydrophilicity, surface functionalization, surface topography, shape, or any combination thereof. In some embodiments, the particle type is comprised in a plurality of different particle types, and wherein the particle type comprises or is associated with a first physicochemical property and another particle type of the plurality of particle types comprises or is associated with a second physicochemical property. In some embodiments, the particle type and the other particle type comprise different surface functionalizations. In some embodiments, the mass spectrum is generated from biomolecules enriched using surface-adsorption. In some embodiments, the mass spectrum is generated by incubating a biological sample with one or more surfaces, isolating biomolecules adsorbed to the surfaces, and performing mass spectrometry on the isolated biomolecules. In some embodiments, the isolated biomolecules are digested before performing mass spectrometry. In some embodiments, the biological sample comprises plasma, serum, urine, cerebrospinal fluid, synovial fluid, tears, saliva, whole blood, milk, nipple aspirate, ductal lavage, vaginal fluid, nasal fluid, ear fluid, gastric fluid, pancreatic fluid, trabecular fluid, lung lavage, sweat, crevicular fluid, semen, prostatic fluid, sputum, fecal matter, bronchial lavage, fluid from swabbings, bronchial aspirants, fluidized solids, fine needle aspiration samples, tissue homogenates, lymphatic fluid, cell culture samples, or any combination thereof. In some embodiments, the biological sample comprises proteins. In some embodiments, the mass spectrum is generated from tandem liquid chromatography-mass spectrometry (LC-MS/MS). In some embodiments, the mass spectrum comprises an MS1 spectrum of the LC-MS/MS. In some embodiments, the mass spectrum comprises an MS2 spectrum of the LC-MS/MS. In some embodiments, the mass spectrum comprises a mass spectrum from sequential mass spectrometry (MSⁿ). In some embodiments, the sequential mass spectrometry is tandem liquid chromatography-sequential mass spectrometry (LC-MSⁿ). In some embodiments, n equals at least 3, 4, 5, 6, 7, 8, 9, or 10. In some embodiments, the mass spectrum is provided to the first layer as an image map. In some embodiments, the image map is subjected to one or more image processing operations. In some embodiments, the image processing operation comprises an image compression operation, an image filtering operation, an object detection operation, an image concatenation operation, an image segmentation operation, an image downsampling operation, or any combination thereof. In some embodiments, intensity values of the mass spectrum are log-transformed. In some embodiments, the neural network comprises a plurality of layers interposed between the first layer and the output layer. In some embodiments, the plurality of layers comprises at least 2, 3, 4, 5, 6, 7, 8, 9, or 10 layers. In some embodiments, the neural network comprises a plurality of neural network blocks. In some embodiments, a neural network block of the plurality of neural network blocks comprises a fully-connected dense layer. In some embodiments, a neural network block of the plurality of neural network blocks comprises a depth-wise convolutional layer. In some embodiments, the neural network comprises a plurality of residual connections. In some embodiments, a neural network block of the plurality of neural network blocks comprises a batch normalization layer. In some embodiments, a neural network block of the plurality of neural network blocks comprises a global average pooling layer. In some embodiments, a neural network block of the plurality of neural network blocks comprises a rescaling layer. In some embodiments, a neural network block of the plurality of neural network blocks comprises a cross-channel convolutional layer. In some embodiments, a neural network block of the plurality of neural network blocks comprises a multiplication layer. In some embodiments, a neural network block of the plurality of neural network blocks comprises a dropout layer. In some embodiments, a neural network block of the plurality of neural network blocks comprises an attention layer.

An additional aspect of the present disclosure provides for a method for identifying potential operational errors in mass spectrometry measurements, comprising: (a) contacting a plurality of biomolecules with a first surface and a second surface to adsorb the plurality of biomolecules thereon; (b) desorbing the plurality of biomolecules from (i) the first surface to generate a first sample, and (ii) the second surface to generate a second sample; (c) performing mass spectrometry using (i) the first sample to generate a first mass spectrum, and (ii) the second sample to generate a second mass spectrum; and (d) determining, using a neural network, whether the first mass spectrum is associated with signals from biomolecules desorbed from the first surface or the second surface, wherein a potential operational error exists when the first mass spectrum is not associated with signals from biomolecules desorbed from first surface.

In some embodiments, the method further comprises repeating (d) with one or more additional neural networks to provide a plurality of determinations and determining the potential operational error exists based on the plurality of determinations. In some embodiments, the neural network comprises any neural network disclosed herein. In some embodiments, each neural network of the one or more additional neural networks comprises any neural network disclosed herein.

An additional aspect of the present disclosure provides for a method for obtaining an neural network as disclosed herein, the method comprising: (a) providing a dataset comprising a plurality of mass spectra, wherein a first subset of the mass spectra is labeled with an anomaly indicator and a second subset of the mass spectra is not labeled with an anomaly indicator; (b) training a neural network, on a training subset of the dataset, to distinguish between the first subset and the second subset; and (c) testing the neural network on a holdout subset of the dataset to relabel a third subset of mass spectra in the plurality of mass spectra, thereby recategorizing a portion of (i) the first subset as non-anomalous, (ii) the second subset as anomalous, or (iii) both.

In some embodiments, the training in (b) comprises training the neural network for a plurality of epochs. In some embodiments, the method further comprises after each epoch, validating the neural network on a validation subset of the dataset, wherein the validation subset is not comprised in the training subset and is not comprised in the holdout subset. In some embodiments, the method further comprises repeating (a)-(c) one or more times to obtain an ensemble of machine learning models.

An additional aspect of the present disclosure provides for a computer-implemented system for identifying potential operational errors in mass spectrometry measurements on a cloud platform, comprising: at least one digital processing device comprising at least one processor, an operating system configured to perform executable instructions, a computer memory, and a computer program including instructions that, upon execution by the at least one processor, cause the at least one processor to perform operations including receiving experimental parameter data for a set of biological samples; receiving mass spectrometry data characterizing the set of biological samples; instantiating a serverless cloud computing instance; analyzing the mass spectrometry data using the serverless cloud computing instance, wherein the analyzing comprises associating, with the aid of a neural network, the mass spectrometry data with one or more experimental parameters; and identifying samples with experimental parameter data inconsistent with a neural network association.

In some embodiments, the neural network comprises the neural network comprises any neural network disclosed herein.

An additional aspect of the present disclosure provides for a neural network for assessing a biological sample, comprising: a first layer that receives a mass spectrum of a biomolecule, or derivative thereof, from the biological sample; and a second layer, in operable communication with the first layer, that outputs a classification of the mass spectrum to a category among a plurality of categories.

In some embodiments, the plurality of categories comprises a subject characteristic associated with a subject from which the biological sample is derived. In some embodiments, the subject characteristic comprises age, gender, race, ethnicity, medical history, current or previous disease state, risk of disease state, current or previous heal status, current or previous therapeutic intervention, or any combination thereof.

An additional aspect of the present disclosure provides for a method for assessing a biological sample, comprising: receiving a dataset characterizing the biological sample, wherein the dataset comprises a mass spectrum of a biomolecule, or derivative thereof, from the biological sample; and processing the dataset using a neural network to classify the biological sample to a category among a plurality of categories. In some embodiments, the neural network any neural network as disclosed herein. In some embodiments, the plurality of categories comprises a subject characteristic associated with a subject from which the biological sample is derived. In some embodiments, the subject characteristic comprises age, gender, race, ethnicity, medical history, current or previous disease state, risk of disease state, current or previous heal status, current or previous therapeutic intervention, or any combination thereof.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a workflow schematic for classifying mass spectrometry data, in accordance with some embodiments of the disclosure.

FIG. 2 shows the block architecture of a trained algorithm configured to classify mass spectrometry data, in accordance with some embodiments of the disclosure.

FIG. 3 shows schematic representations of the constituent layers of the modules of the model depicted in FIG. 2.

FIG. 4 depicts a plurality of models for classifying mass spectrometric data, in accordance with some embodiments of the disclosure.

FIG. 5 provides a schematic showing the basic workflow of the quality control method utilizing a neural network model to process MS1 scan data as an image in accordance with some embodiments.

FIGS. 6A-B illustrate representative TIC mass spectra indicative of normal runs and operational error(s), respectively.

FIG. 7 shows a series of MS1 scans acquired and processed by methods and algorithms as disclosed herein.

FIGS. 8A-8D show the results of training a neural network in accordance with the present disclosure.

FIG. 9A depicts a classification accuracy matrix in accordance with some embodiments.

FIG. 9B depicts a principal component analysis plot of the output one layer from an image analysis in accordance with some embodiments.

FIG. 10 depicts a classification accuracy matrix in accordance with some embodiments.

FIG. 11 depicts a classification accuracy matrix in accordance with some embodiments.

FIG. 12 depicts a classification accuracy matrix in accordance with some embodiments.

FIG. 13 depicts a classification accuracy matrix in accordance with some embodiments.

FIG. 14 shows a computer control system that is programmed or otherwise configured to implement methods provided herein.

FIG. 15 schematically illustrates a cloud-based distributed computing environment, in accordance with some embodiments.

### DETAILED DESCRIPTION

### Introduction

Currently available platforms, software, and data structures used for processing mass spectrometry datasets have numerous limitations that make it difficult to process hundreds and thousands of samples. When conducting analysis of deep biological sample profiling experiments, technical confounding can be introduced as samples are acquired, processed, and analyzed across by different users, different machines, and different spatiotemporal circumstances. For instance, technical confounding can be introduced when samples are analyzed using different MS instruments, LC columns, dates, and geographic locations. Further, instrument, human, and other sources of error can introduce variations or anomalies. This may include, for example, sample cross-over or contamination.

Performing robust quality control (QC) can improve overall protein identification and quantification, and yield more accurate statistical estimates of differential abundance by detecting outlier data points. The sources of variability in a proteomics experiment that are addressed by QC can be categorized into two groups: biological and technical. The goal of QC is to not remove normal biological variability; however, there are circumstances where an LC-MS analysis displays outlier behavior and should be flagged and evaluated. Technical variability can be associated with sample collection, transportation, storage, preparation, and/or instrument performance. Teasing out the cause of outliers in the category of technical variability can be extremely challenging.

Current tools developed to assess LC-MS-based proteomics data quality in the context of an entire study are implemented as post-hoc analyses to be utilized at the end of the experiment. Some examples are web-based applications that track individual QC metrics on the fly with varying levels of sophistication. However, these metrics may only provide a global view of the performance, but not pinpoint specific elements of the workflow where a failure might have arisen.

In some aspects, the present disclosure describes quality control (QC) methods for use in conjunction with mass spectrometry workflows. In some embodiments, the mass spectrometry workflow comprises applying quality control (QC) based on identifying differences in the distribution of key biological samples from batch-to batch. In some embodiments, the mass spectrometry workflow comprises applying quality control (QC) for screening contaminated samples. In some embodiments, the mass spectrometry workflow comprises applying quality control (QC) based on estimating purity of the biological samples. In some embodiments, the mass spectrometry workflow comprises applying quality control (QC) identifying degradation in biological samples.

Methods, systems, and algorithms are disclosed herein which are able to process mass spectrometry datasets to identify evidence of operational errors. Methods, systems, and algorithms of the disclosure may be configured to associate a mass spectrum with an experimental parameter by identifying features in the mass spectrum that are indicative of the experimental parameter. In cases where an anomalous mass spectrum is presented to the methods, systems, or algorithms of the disclosure, the mass spectrum may not be associated with the experimental parameter. Such spectra can be flagged for further investigation to determine the source of the anomaly.

In some aspects, the present disclosure describes image analysis methods, systems, and algorithms for use in conjunction with mass spectrometry workflows. In some embodiments, the mass spectrometry workflow comprises generating image maps to monitor batch-to-batch variability in biological samples. In some embodiments, the mass spectrometry workflow comprises generating image maps to detect presence of contaminants in biological samples. In some embodiments, the mass spectrometry workflow comprises generating image maps to assess the purity of biological samples by measuring the relative intensity of different ions. In some embodiments, the mass spectrometry workflow comprises generating image maps to monitor the stability of samples over time.

In some aspects, the present disclosure describes image analysis methods, systems, and algorithms for use in conjunction with mass spectrometry workflows. In some embodiments, the mass spectrometry workflow comprises use of particles combined with liquid chromatography-mass spectrometry (LC-MS) to enable deep untargeted proteomics. In some embodiments, methods, systems, and algorithms of the present disclosure are configured to analyze image maps based on mass spectrometry (e.g., LC-MS) to identify potential quality control (QC) issues for further investigation. The methods, systems, and algorithms of the present disclosure may be configured to identify unexpected patterns and highlight potential issues for further investigation. The methods, systems, and algorithms of the disclosure can enable real-time monitoring of data quality, facilitate troubleshooting analysis for root cause investigations, and ensure that only high-quality data are used for analysis. The following paragraphs provide illustrative embodiments that detail various aspects of the computational platforms of the present disclosure.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, a “feature” identified by mass spectrometry includes a signal at a specific combination of retention time and m/z (mass-to-charge ratio), where each feature has an associated intensity. Some features are further fragmented in a second mass spectrometry analysis (MS2) for identification.

As used herein, the term “biomolecule corona” generally refers to the plurality of different biomolecules that bind to a sensor element. The term “biomolecule corona” generally refers to the proteins, lipids and other plasma components that bind to particles (e.g., nanoparticles) when they come into contact with biological samples or biological system. For use herein, the term “biomolecule corona” also encompasses both the soft and hard protein corona as referred to in Milani et al. “Reversible versus Irreversible Binding of Transferring to Polystyrene Nanoparticles: Soft and Hard Corona” ACS NANO, 2012, 6(3), pp. 2532-2541; Mirshafiee et al. “Impact of protein pre-coating on the protein corona composition and nanoparticle cellular uptake” Biomaterials vol. 75, January 2016 pp. 295-304, Mahmoudi et al. “Emerging understanding of the protein corona at the nano-bio interfaces” Nanotoday 11(6) December 2016, pp. 817-832, and Mahmoudi et al. “Protein-Nanoparticle Interactions: Opportunities and Challenges” Chem. Rev., 2011, 111(9), pp. 5610-5637, the contents of which are incorporated by reference in their entireties. As described therein, an adsorption curve may show the build-up of a strongly bound monolayer up to the point of monolayer saturation (at a geometrically defined protein-to-NP ratio), beyond which a secondary, weakly bound layer is formed. While the first layer is irreversibly bound (hard corona), the secondary layer (soft corona) may exhibit dynamic exchange. Proteins that adsorb with high affinity may form the “hard” corona, comprising tightly bound proteins that do not readily desorb, and proteins that adsorb with low affinity may form the “soft” corona, comprising loosely bound proteins. Soft and hard corona can also be characterized based on their exchange times. Hard corona may show much larger exchange times in the order of several hours. See, e.g., M. Rahman et al. Protein-Nanoparticle Interactions, Spring Series in Biophysics 15, 2013, incorporated by reference in its entirety.

The term “biomolecule corona signature” generally refers to the composition, signature or pattern of different biomolecules that are bound to each type of particle or separate sensor element. The signature may not only refer to the different biomolecules but also the differences in the amount, level or quantity of the biomolecule bound to the sensor element, or differences in the conformational state of the biomolecule that is bound to the particle or sensor element. It is contemplated that the biomolecule corona signatures of each distinct type of sensor elements may contain some of the same biomolecules, may contain distinct biomolecules with regard to the other sensor elements, and/or may differ in level or quantity, type, or conformation of various biomolecules. The biomolecule corona signature may depend on not only the physicochemical properties of the sensor element (e.g., particle), but also the nature of the sample and the duration of exposure to the biological sample.

“Biomolecule” as used in “biomolecule corona” generally refers to any molecule or biological component that can be produced by, or is present in, a biological organism. Non-limiting examples of biomolecules include proteins (protein corona), polypeptides, oligopeptides, polyketides, polysaccharides, a sugar, a lipid, a lipoprotein, a metabolite, an oligonucleotide, a nucleic acid (DNA, RNA, micro RNA, plasmid, single stranded nucleic acid, double stranded nucleic acid), metabolome, as well as small molecules such as primary metabolites, secondary metabolites, and other natural products, or any combination thereof. In some embodiments, the biomolecule is selected from the group of proteins, nucleic acids, lipids, and metabolomes.

As used herein, the term “sensor element” generally refers to elements that are able to bind to a plurality of biomolecules when in contact with a sample and encompasses the term “nanoscale sensor element”. A sensor element may be a particle, such as a nanoparticle, or microparticle. A sensor element may be a surface or a portion of a surface. A sensor element may comprise a particle or plurality of particles. A sensor element may comprise a plurality of surfaces capable of adsorbing or binding biomolecules. A sensor element may comprise a porous material, such as a material into which biomolecules can intercalate.

As used herein, a “sensor array” may comprise a plurality of sensor elements wherein the plurality of sensor elements (e.g., particles) comprises multiple types of sensor elements. The sensor elements may be different types that differ from each other in at least one physicochemical property. A sensor array may be a substrate with differentially modified surface regions. A sensor array may be a substrate with a plurality of partitions containing a plurality of sensor elements (e.g., particles). For example, a sensor array may comprise a multi-well plate with a plurality of particles distributed between the plurality of wells. A sensor array may be a substrate comprising a plurality of partitions, wherein the plurality of partitions comprises a plurality of particles. In some cases, each sensor element or particle is able to bind a plurality of biomolecules in a sample to produce a biomolecule corona signature. In some embodiments, each sensor element (e.g., particle type) has a distinct biomolecule corona signature.

### Methods and Systems for Classification of Mass Spectrometry Measurements

In some aspects, the present disclosure provides methods, systems, and algorithms for analyzing mass spectrometry data. The methods, systems, and algorithms of the present disclosure may be configured to output a classification of a mass spectrum, or a biological sample or subject from which the mass spectrum was derived. The methods, systems, and algorithms of the present disclosure may be configured as described herein (e.g., by training as described herein) to recognize certain patterns or features in mass spectra or representations thereof which are associated with certain experimental or subject parameters of the mass spectra (or biological sample or subject from which they are derived) and classify the mass spectra on the basis of the identification and/or analysis of these features.

In some embodiments, the methods, systems, and algorithms of the present disclosure may comprise a neural network. The neural network may comprise a pre-trained neural network, a customized neural network, or a combination thereof. The neural network may comprise a deep neural network. The neural network may comprise one or more multi-layer perceptron (MLP), recurrent neural networks, convolutional neural networks, or attention-based (e.g., transformer) neural networks. In some embodiments, the neural network comprises or is configured from a pretrained neural network. The pretrained neural network may comprise or be based on one or more of VGG-19, ResNet, Inception, MobileNet, or EfficientNet. The neural network may comprise a first layer which is configured to receive a mass spectrum. The mass spectrum may be comprised in a plurality of mass spectra. Alternatively, or additionally, the first layer may be configured to receive a representation or transformation of the mass spectrum or mass spectra. In some embodiments, the representation comprises an image map comprising or based on a plurality of mass spectra as described herein. The neural network may further comprise a second layer configured to output a classification of the mass spectrum. The classification may be of among a plurality of measurement types associated with an experimental parameter of the mass spectrum. The experimental parameter may be associated with any aspect or feature of the mass spectrometry workflow or sample analyzed by mass spectrometry. The number of layers in the neural network is not particularly limited and may vary.

In some embodiments, methods, systems, and algorithms of the present disclosure are configured to associate the mass spectrum with an experimental parameter characterizing the mass spectrometry assay. In some embodiments, the mass spectrometry comprises liquid chromatography-mass spectrometry (LC-MS). In some embodiments, the mass spectrum comprises a mass spectrum from sequential mass spectrometry (MSⁿ). In some embodiments, the sequential mass spectrometry is tandem liquid chromatography-sequential mass spectrometry (LC-MSⁿ). In some embodiments, the sequential mass spectrometry comprises at least 3, 4, 5, 6, 7, 8, 9, 10, or more sequential mass spectrometry assays (e.g., an MSⁿ assay where n is at least 3, 4, 5, 6, 7, 8, 9, or 10). In some embodiments, n is at most 10, 9, 8, 7, 6, 5, 4, or 3. In some embodiments, the mass spectrometry comprises tandem mass spectrometry (MS/MS or MS2). In some embodiments, the mass spectrometry assay comprises liquid chromatography-tandem mass spectrometry (LC-MS/MS). In some embodiments, the mass spectrum comprises an MS1 spectrum. In some embodiments, the mass spectrum comprises an MS2 spectrum.

In some embodiments, a classification is made without identifying biomolecules within the biological sample that produced the mass spectrum. For example, mass spectra obtained from a plasma sample may be classified without identifying the specific proteins within the plasma sample. In some embodiments, a classification is made without identifying proteins within the biological sample that produced the mass spectrum. In some embodiments, a classification is made without identifying peptides derived from the biological sample that produced the mass spectrum.

In some embodiments, the experimental parameter comprises assay volume, temperature, humidity, position, chromatographic conditions, gradient length, column type, column packing material, LC system pressure, ionizer type, detector type, inner diameter, peak capacity, flow rate, buffer type, pH, temperature, presence of a contamination, or any combination thereof. In some embodiments. In some embodiments, the experimental parameter comprises the experimental parameter comprises assay volume. In some embodiments, the experimental parameter comprises temperature. In some embodiments, the experimental parameter comprises humidity. In some embodiments, the experimental parameter comprises position. In some embodiments, the experimental parameter comprises chromatographic conditions. In some embodiments, the experimental parameter comprises gradient length. In some embodiments, the experimental parameter comprises column type. In some embodiments, the experimental parameter comprises column packing material. In some embodiments, the experimental parameter comprises LC system pressure. In some embodiments, the experimental parameter comprises ionizer type. In some embodiments, the experimental parameter comprises detector type. In some embodiments, the experimental parameter comprises inner diameter. In some embodiments, the experimental parameter comprises peak capacity. In some embodiments, the experimental parameter comprises flow rate. In some embodiments, the experimental parameter comprises buffer type. In some embodiments, the experimental parameter comprises pH. In some embodiments, the experimental parameter comprises temperature. In some embodiments, the experimental parameter comprises presence of a contamination.

In some embodiments, the mass spectrum is taken from or characterizes (e.g., at least a portion of) a biological sample. In some embodiments, the experimental parameter characterizes or is indicative of the biological sample. In some embodiments, the methods, systems, and algorithms of the present disclosure are configured to identify, associate, or classify a mass spectrum with a biological sample or experimental characterizing the biological sample. In some embodiments, the experimental parameter comprises an organ type of the biological sample, a tissue type of the biological sample, a cell type of the biological sample, a volume of the biological sample, a dilution of the biological sample, a physical or chemical treatment of the sample, or any combination thereof. In some embodiments, the experimental parameter comprises an organ type of the biological sample. In some embodiments, the experimental parameter comprises a tissue type of the biological sample. In some embodiments, the experimental parameter comprises a cell type of the biological sample. In some embodiments, the experimental parameter comprises a volume of the biological sample. In some embodiments, the experimental parameter comprises a dilution of the biological sample. In some embodiments, the experimental parameter comprises a chemical or physical treatment of the biological sample. In some embodiments, the experimental parameter comprises sample preparation methods for the biological sample. In some embodiments, the experimental parameter comprises centrifugation conditions for blood, plasma or serum (e.g., centrifugation speed, time, etc.). In some embodiments, the experimental parameter comprises anticoagulation conditions (e.g., the addition of EDTA, heparin, citrate, oxalate, or other anticoagulants). In some embodiments, the experimental parameter is the presence of a plasma or serum sample. In some embodiments, the experimental parameter is a threshold amount of cellular contamination is cell-free biological sample, such as plasma or serum.

In some embodiments, the biological sample is obtained from a subject and the experimental parameter comprises a characteristic of the subject. In some embodiments, the characteristic of the subject comprises age, gender, race, ethnicity, medical history, current or previous disease state, current or previous health status, risk of disease state, current or previous therapeutic intervention, or any combination thereof. In some embodiments, the characteristic of the subject comprises the subject characteristic comprises age. In some embodiments, the characteristic of the subject comprises gender. In some embodiments, the characteristic of the subject comprises race. In some embodiments, the characteristic of the subject comprises ethnicity. In some embodiments, the characteristic of the subject comprises medical history. In some embodiments, the characteristic of the subject comprises current or previous disease state. In some embodiments, the characteristic of the subject comprises current or previous health status. In some embodiments, the characteristic of the subject comprises risk of disease state. In some embodiments, the characteristic of the subject comprises current or previous therapeutic intervention.

In some embodiments, the mass spectrometry assay comprises an operation of contacting the biological sample (or potion thereof) with a surface as described herein. In some embodiments, the mass spectrometry assay comprises contacting the sample with a plurality of surfaces as described herein. Optionally, the mass spectrometry assay may further comprise isolating biomolecules adsorbed to the surface and performing mass spectrometry on the isolated biomolecules. In such embodiments, the experimental parameter may comprise a surface type or functionalization or (e.g., physicochemical) property associated with a surface as described herein. Surfaces (e.g., particles) comprising differing physicochemical properties may lead to different mass spectra or different features in mass spectra due to preferentially interacting with certain subsets of biomolecules in the biological sample. Methods, systems, and algorithms of the present disclosure may be configured to identify these differences and associate mass spectra with the corresponding surfaces (e.g., particles) and/or physicochemical properties. In some embodiments, the physicochemical property comprises size, surface charge, zeta potential, hydrophobicity, hydrophilicity, surface functionalization, surface topography, shape, or any combination thereof. In some embodiments, the physicochemical property comprises size. In some embodiments, the physicochemical property comprises surface charge. In some embodiments, the physicochemical property comprises zeta potential. In some embodiments, the physicochemical property comprises hydrophobicity. In some embodiments, the physicochemical property comprises hydrophilicity. In some embodiments, the physicochemical property comprises surface functionalization. In some embodiments, the physicochemical property comprises surface topography. In some embodiments, the physicochemical property comprises shape. In some embodiments, the physicochemical property comprises or any combination thereof. In some embodiments, the methods, systems, and algorithms of the present disclosure may be configured to classify or associate a mass spectrum with a particle type from among a plurality of particle types.

In some cases, a biological sample may be contacted with a plurality of surfaces having different physicochemical properties with a single volume. The methods, systems, and algorithms of the present disclosure may be configured to classify or associate a mass spectrum with the plurality of surfaces within the single volume. In some cases, a biological sample may be contacted with a plurality of surfaces having different physicochemical properties in separate volumes, and then the biomolecules are combined into a single volume before performing mass spectrometry. The methods, systems, and algorithms of the present disclosure may be configured to classify or associate a mass spectrum with the plurality of surfaces used within the separate volumes.

As a non-limiting example, a biological sample may be contacted with a plurality of particles to form a biomolecule corona, and the contents of the biomolecule corona may be analyzed using mass spectrometry. Such methods are disclosed in U.S. Publication No. 2018/0172694; U.S. Publication No. 2021/0285957; U.S. Publication No. 2021/0285958; and International Publication No. WO 2022/020272, each of which is hereby incorporated by reference in its entirety. The systems, methods, and algorithms of the present disclosure may, in some embodiments, classify or associate the mass spectrometry data with a type of particle used to form the biomolecule corona. The skilled person, guided by the teachings of the present application, will appreciate that mass spectrometry data may be classified based on other experimental parameters, such as the incubation conditions for biomolecule corona formation (e.g., time, temperature, pH, and the like), the type of biological sample, and the like.

### Methods and Systems for Quality Control of Mass Spectrometric Measurements

In some embodiments, the methods, systems, and algorithms of the present disclosure may be configured for identifying operational errors in mass spectrometry measurements. The methods, systems, and algorithms for identifying operational errors may comprise a neural network as described herein. In some embodiments, the neural network is configured to identify features which are indicative of operational errors in the mass spectrum and classify the mass spectrum as being indicative of a presence of an operational error. In some embodiments, identifying operational errors in a mass spectrum comprises an operation of contacting a plurality of biomolecules with a surface to adsorb the plurality of biomolecules. In some embodiments, the contacting the plurality of biomolecules comprises contacting the plurality of biomolecules with a plurality of surfaces. Optionally, the adsorbed biomolecules may be separated for the surface for downstream processing. In some embodiments, plurality of biomolecules (or the separated biomolecules) are subjected to mass spectrometry to generate a mass spectrum. The mass spectrum may then be analyzed with a trained algorithm (e.g., neural network) as described herein to determine the presence of an operational error. In some embodiments, identifying the operational error further comprises determining the operational error is present when the mass spectrum is not associated by the neural network with signals from the plurality of biomolecules (or separated biomolecules). In such cases, the neural network may not associate the mass spectrum with the signals because the presence of the operational error has altered the mass spectrum such that features the neural network has learned to associate with the expected signals are no longer present. In some embodiments, the neural network may be configured to classify the mass spectrum as comprising an operational error.

In some embodiments, algorithms (e.g., neural networks) as described herein for detecting potential operational errors in mass spectrometry datasets by be directly trained on anomalous mass spectrometry data sets. Anomalous mass spectrometry datasets or anomalous mass spectra may generally comprise mass spectra apriori associated with an experimental parameter as described herein (e.g., due to being processed with a preselected mass spectrometric assay, due to being derived from a preselected biological sample or preselected subject) that are nevertheless not identified by methods, systems, and/or algorithms of the present disclosure as associated with the experimental parameter. That is, due to the presence of an operational error in the sample preparation, acquisition or processing of the mass spectrometry data, the mass spectrum appears anomalous and can no longer be recognized as associated with the expected experimental parameters.

In some embodiments, an operational error is identified without identifying biomolecules within the biological sample that produced the mass spectrum. For example, mass spectra obtained from a plasma sample may be identified as having an operational error without identifying the specific proteins within the plasma sample. In some embodiments, an operational error is identified without identifying proteins within the biological sample that produced the mass spectrum. In some embodiments, an operational error is identified without identifying peptides derived from the biological sample that produced the mass spectrum.

In some embodiments, the methods, systems, and/or algorithms of the present disclosure are configured to identify evidence of operational errors in mass spectrometry datasets. During training, algorithms of the present disclosure (e.g., neural networks) are configured to identify which features or portions of a mass spectrum are relevant for assessing the presence of an operational error and to detect their presence in mass spectra. In some embodiments, methods of training a neural network to detect potential operation errors in mass spectrometry datasets comprises providing a dataset comprising a plurality of mass spectra, wherein a first subset of the mass spectra is labeled with an anomaly indicator and a second subset of the mass spectra is not labeled with an anomaly indicator. The anomaly indicator may identify those mass spectrometry that are anomalous, that is, displaying properties or features which are not expected based on the associated experimental parameters of the dataset (e.g., parameters of the mass spectrometry assay, surface, biological sample, or subject from which the biological sample was derived). The methods of training a neural network to identify potential operational errors in mass spectrometry dataset may further comprise an operation of training a neural network, on a training subset of the dataset, to distinguish between the first subset and the second subset. During the training process, the neural network is “taught” to extract and recognize which features are associated with anomalous datasets. In some embodiments, the methods of training a neural network to identify potential operational errors in mass spectrometry datasets may comprise testing the neural network on a holdout subset of the dataset to relabel a third subset of mass spectra in the plurality of mass spectra. Based on the training, the neural network may recategorize a portion of (i) the first subset as non-anomalous, (ii) the second subset as anomalous, or (iii) both.

### Biological Sample

Mass spectrometry datasets which can be processed using the methods, systems, and algorithms disclosed herein are not particularly limited and may be generated by assaying one or more biological samples. In some embodiments, a biological sample may comprise a cell or be cell-free sample. In some embodiments, a biological sample may comprise a biofluid, such as blood, serum, plasma, urine, or cerebrospinal fluid (CSF). In some embodiments, a biofluid may be a fluidized solid, for example a tissue homogenate, or a fluid extracted from a biological sample. A biological sample may be, for example, a tissue sample or a fine needle aspiration (FNA) sample. A biological sample may be a cell culture sample. For example, a biofluid may be a fluidized cell culture extract or a cell-free, cell culture medium. In some embodiments, a biological sample may be obtained from a subject. In some embodiments, the subject may be a human or a non-human. In some embodiments, the subject may be a plant, a fungus, or an archaeon. In some embodiments, a biological sample can contain a plurality of proteins or proteomic data, which may be analyzed after adsorption or binding of proteins to the surfaces of the various sensor element (e.g., particle) types in a panel and subsequent digestion of protein coronas.

In some embodiments, the plurality of samples comprises at least 500, 5000, or 50000 samples. In some embodiments, the plurality of samples comprises at most 5000, 50000, 500000 samples. In some embodiments, the plurality of samples comprises a complex sample. In some embodiments, the complex sample comprises at least 100, 1000, 10000, 100000, or 1000000 unique biomolecules. In some embodiments, the complex sample comprises at least 100, 1000, 10000, 100000, or 1000000 unique proteins. In some embodiments, the complex sample comprises at most 1000, 10000, 100000, 1000000, or 10000000 unique biomolecules. In some embodiments, the complex sample comprises at most 1000, 10000, 100000, 1000000, or 10000000 unique proteins. In some embodiments, the complex sample comprises a biomolecule comprising at least about 0.1, 1, 10, 100, or 1000 kiloDaltons (kDa) in molecular weight. In some embodiments, the complex sample comprises a biomolecule comprising at most about 1, 10, 100, 1000, or 10000 kiloDaltons (kDa) in molecular weight.

In some embodiments, a biological sample may comprise plasma, serum, urine, cerebrospinal fluid, synovial fluid, tears, saliva, whole blood, milk, nipple aspirate, ductal lavage, vaginal fluid, nasal fluid, ear fluid, gastric fluid, pancreatic fluid, trabecular fluid, lung lavage, sweat, crevicular fluid, semen, prostatic fluid, sputum, fecal matter, bronchial lavage, fluid from swabbings, bronchial aspirants, fluidized solids, fine needle aspiration samples, tissue homogenates, lymphatic fluid, cell culture samples, or any combination thereof. In some embodiments, a biological sample may comprise multiple biological samples (e.g., pooled plasma from multiple subjects, or multiple tissue samples from a single subject). In some embodiments, a biological sample may comprise a single type of biofluid or biomaterial from a single source.

In some embodiments, a biological sample may be diluted or pre-treated. In some embodiments, a biological sample may undergo depletion (e.g., the biological sample comprises serum) prior to or following contact with a surface disclosed herein. In some embodiments, a biological sample may undergo physical (e.g., homogenization or sonication) or chemical treatment prior to or following contact with a surface disclosed herein. In some embodiments, a biological sample may be diluted prior to or following contact with a surface disclosed herein. In some embodiments, a dilution medium may comprise buffer or salts, or be purified water (e.g., distilled water). In some embodiments, a biological sample may be provided in a plurality partition, wherein each partition may undergo different degrees of dilution. In some embodiments, a biological sample may comprise may undergo at least about 1.1-fold, 1.2-fold, 1.3-fold, 1.4-fold, 1.5-fold, 2-fold, 3-fold, 4-fold, 5-fold, 6-fold, 8-fold, 10-fold, 12-fold, 15-fold, 20-fold, 30-fold, 40-fold, 50-fold, 75-fold, 100-fold, 200-fold, 500-fold, or 1000-fold dilution.

In some embodiments, the biological sample may comprise a plurality of biomolecules. In some embodiments, a plurality of biomolecules may comprise poly(amino acid)s. In some embodiments, the poly(amino acid)s comprise peptides, proteins, or a combination thereof. In some embodiments, the plurality of biomolecules may comprise nucleic acids, carbohydrates, poly(amino acid)s, or any combination thereof. In some embodiments, a poly(amino acid) may be a proteolytic peptide. In some embodiments, a poly(amino acid) may be a tryptic peptide. In some embodiments, a poly(amino acid) may be a semi-tryptic peptide. A biological sample may comprise a member of any class of biomolecules, where “classes” may refer to any named category that defines a group of biomolecules having a common characteristic (e.g., proteins, nucleic acids, carbohydrates).

### Assays

In some embodiments, the methods, systems, and algorithms may be applied to a mass spectrometry dataset generated by performing an assay. In some embodiments, the assay comprises a plurality of assays. In some embodiments, the assay(s) is (are) performed on a plurality of samples to generate a plurality of mass spectrometry datasets.

In some embodiments, an assay comprises selectively enriching a plurality of chemicals in the plurality of samples. In some embodiments, the selectively enriching comprises contacting the plurality of samples with a surface. In some embodiments, the selectively enriching comprises contacting the plurality of samples with a plurality of surfaces. In some embodiments, the selectively enriching comprises contacting the plurality of samples with a plurality of surfaces comprising distinct surface chemistries. In some embodiments, the contacting adsorbs the plurality of chemicals on the surface. In some embodiments, the contacting non-specifically binds the plurality of chemicals on the surface. In some embodiments, the surface comprises a particle surface of a particle. In some embodiments, the contacting forms a corona on the particle surface. In some embodiments, the particle comprises a paramagnetic core.

In some embodiments, the plurality of chemicals comprises a dynamic range of at least about 1, 2, 3, 4, 5, 6, 7, 8, 9, 10, 11, 12, 13, 14, 15, 16, 17, 18, or 19. In some embodiments, the plurality of chemicals comprises a dynamic range of at most about 1, 2, 3, 4, 5, 6, 7, 8, 9, 10, 11, 12, 13, 14, 15, 16, 17, 18, or 19. In some embodiments, the plurality of chemicals, when adsorbed, comprises a dynamic range that is decreased by at least about 1, 2, 3, 4, 5, 6, 7, 8, 9, 10, 11, 12, 13, 14, or 15 magnitudes. In some embodiments, the selectively enriching comprises releasing the plurality of chemicals from the surface. In some embodiments, the plurality of assays comprises performing mass spectrometry on the plurality of samples.

Mass Spectrometry (MS) is an analytical technique that can be used for identifying the amount and type of chemicals present in a sample, determining the elemental composition of samples, quantitating the mass of particles and molecules, and elucidating the chemical structure of molecules by measuring the mass-to-charge ratio and the abundance of gas-phase ions. Various types of MS-based technologies with high specificity, such as liquid chromatography (LC-MS), gas chromatography (GC-MS), desorption electrospray ionization, and matrix-assisted laser desorption/ionization/time-of-flight (MALDI-TOF MS), can be utilized as part of the systems and methods described herein.

In cases where a MS detector is utilized, the presence or absence of the substances or substances may be detected based on their ionization patterns in the mass spectrometer. The ions are accelerated under vacuum in an electric field and separated by mass analyzers according to their m/z ratios. Representative mass analyzers for use with the methods and systems disclosed herein include triple-quadrupole, time-of-flight (TOF), magnetic sector, orbitrap, ion trap, quadrupole-TOF, matrix-assisted laser desorption ionization (MALDI), ion mobility, and Fourier transform ion cyclotron resonance (FTICR) analyzers, and the like.

In some cases, the plurality of chemicals can be assayed using non-specific binding. A surface may bind biomolecules through variably selective adsorption (e.g., adsorption of biomolecules or biomolecule groups upon contacting the particle to a biological sample comprising the biomolecules or biomolecule groups, which adsorption is variably selective depending upon factors including e.g., physicochemical properties of the particle) or non-specific binding. Non-specific binding can refer to a class of binding interactions that exclude specific binding. Examples of specific binding may comprise protein-ligand binding interactions, antigen-antibody binding interactions, nucleic acid hybridizations, or a binding interaction between a template molecule and a target molecule wherein the template molecule provides a sequence or a 3D structure that favors the binding of a target molecule that comprise a complementary sequence or a complementary 3D structure, and disfavors the binding of a non-target molecule(s) that does not comprise the complementary sequence or the complementary 3D structure.

Non-specific binding may comprise one or a combination of a wide variety of chemical and physical interactions and effects. Non-specific binding may comprise electromagnetic forces, such as electrostatics interactions, London dispersion, Van der Waals interactions, or dipole-dipole interactions (e.g., between both permanent dipoles and induced dipoles). Non-specific binding may be mediated through covalent bonds, such as disulfide bridges. Non-specific binding may be mediated through hydrogen bonds. Non-specific binding may comprise solvophobic effects (e.g., hydrophobic effect), wherein one object is repelled by a solvent environment and is forced to the boundaries of the solvent, such as the surface of another object. Non-specific binding may comprise entropic effects, such as in depletion forces, or raising of the thermal energy above a critical solution temperature (e.g., a lower critical solution temperature). Non-specific binding may comprise kinetic effects, wherein one binding molecule may have faster binding kinetics than another binding molecule.

Non-specific binding may comprise a plurality of non-specific binding affinities for a plurality of targets (e.g., at least 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10,000, 20,000, 30,000, 40,000, 50,000 different targets adsorbed to a single particle, or at most 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10,000, 20,000, 30,000, 40,000, 50,000 different targets adsorbed to a single particle). The plurality of targets may have similar non-specific binding affinities that are within about one, two, or three magnitudes (e.g., as measured by non-specific binding free energy, equilibrium constants, competitive adsorption, etc.). This may be contrasted with specific binding, which may comprise a higher binding affinity for a given target molecule than non-target molecules.

Biomolecules may adsorb onto a surface through non-specific binding on a surface at various densities. In some cases, biomolecules or proteins may adsorb at a density of at least about 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900, or 1000 fg/mm². In some cases, biomolecules or proteins may adsorb at a density of at least about 1, 2, 3, 4, 5, 6, 7, 8, 9, 10, 20, 30, 40, 50, 60, 70, 80, 90, 100, 200, 300, 400, 500, 600, 700, 800, 900, or 1000 pg/mm². In some cases, biomolecules or proteins may adsorb at a density of at least about 1, 2, 3, 4, 5, 6, 7, 8, 9, 10, 20, 30, 40, 50, 60, 70, 80, 90, 100, 200, 300, 400, 500, 600, 700, 800, 900, or 1000 ng/mm². In some cases, biomolecules or proteins may adsorb at a density of at least about 1, 2, 3, 4, 5, 6, 7, 8, 9, 10, 20, 30, 40, 50, 60, 70, 80, 90, 100, 200, 300, 400, 500, 600, 700, 800, 900, or 1000 μg/mm². In some cases, biomolecules or proteins may adsorb at a density of at least about 1, 2, 3, 4, 5, 6, 7, 8, 9, 10, 20, 30, 40, 50, 60, 70, 80, 90, 100, 200, 300, 400, 500, 600, 700, 800, 900, or 1000 mg/mm². In some cases, biomolecules or proteins may adsorb at a density of at most about 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900, or 1000 fg/mm². In some cases, biomolecules or proteins may adsorb at a density of at most about 1, 2, 3, 4, 5, 6, 7, 8, 9, 10, 20, 30, 40, 50, 60, 70, 80, 90, 100, 200, 300, 400, 500, 600, 700, 800, 900, or 1000 pg/mm². In some cases, biomolecules or proteins may adsorb at a density of at most about 1, 2, 3, 4, 5, 6, 7, 8, 9, 10, 20, 30, 40, 50, 60, 70, 80, 90, 100, 200, 300, 400, 500, 600, 700, 800, 900, or 1000 ng/mm². In some cases, biomolecules or proteins may adsorb at a density of at most about 1, 2, 3, 4, 5, 6, 7, 8, 9, 10, 20, 30, 40, 50, 60, 70, 80, 90, 100, 200, 300, 400, 500, 600, 700, 800, 900, or 1000 μg/mm². In some cases, biomolecules or proteins may adsorb at a density of at most about 1, 2, 3, 4, 5, 6, 7, 8, 9, 10, 20, 30, 40, 50, 60, 70, 80, 90, 100, 200, 300, 400, 500, 600, 700, 800, 900, or 1000 mg/mm².

Adsorbed biomolecules may comprise various types of proteins. In some cases, adsorbed proteins may comprise at least about 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, or 10000 types of proteins. In some cases, adsorbed proteins may comprise at most about 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, or 10000 types of proteins.

In some cases, proteins in a biological sample may comprise at least about 1, 2, 3, 4, 5, 6, 7, 8, 9, 10, 15, 20, 25, or 30 orders of magnitudes in concentration. In some cases, proteins in a biological sample may comprise at most about 1, 2, 3, 4, 5, 6, 7, 8, 9, 10, 15, 20, 25, or 30 orders of magnitudes in concentration.

### Proteomic Analysis

As used herein, “proteomic analysis”, “protein analysis”, and the like, may refer to any system or method for analyzing proteins in a sample. The systems, methods, and algorithms disclosed herein may be applied to mass spectrometry data generated using an assay to perform proteomic analysis. In some cases, the assaying includes using one or more surfaces. In some cases, a surface may comprise a surface of a high surface-area material, such as nanoparticles, particles, microparticles, or porous materials. As used herein, a “surface” may refer to a surface for assaying poly(amino acid)s. When a particle composition, physical property, or use thereof is described herein, it shall be understood that a surface of the particle may comprise the same composition, the same physical property, or the same use thereof, in some cases. Similarly, when a surface composition, physical property, or use thereof is described herein, it shall be understood that a particle may comprise the surface to comprise the same composition, the same physical property, or the same use thereof.

Materials for particles and surfaces may include metals, polymers, magnetic materials, and lipids. In some cases, magnetic particles may be iron oxide particles. Examples of metallic materials include any one of or any combination of gold, silver, copper, nickel, cobalt, palladium, platinum, iridium, osmium, rhodium, ruthenium, rhenium, vanadium, chromium, manganese, niobium, molybdenum, tungsten, tantalum, iron, cadmium, or any alloys thereof. In some cases, a particle disclosed herein may be a magnetic particle, such as a superparamagnetic iron oxide nanoparticle (SPION). In some cases, a magnetic particle may be a ferromagnetic particle, a ferrimagnetic particle, a paramagnetic particle, a superparamagnetic particle, or any combination thereof (e.g., a particle may comprise a ferromagnetic material and a ferrimagnetic material).

The present disclosure describes panels of particles or surfaces. In some cases, a panel may comprise more than one distinct surface types. Panels described herein can vary in the number of surface types and the diversity of surface types in a single panel. For example, surfaces in a panel may vary based on size, polydispersity, shape and morphology, surface charge, surface chemistry and functionalization, and base material. In some cases, panels may be incubated with a sample to be analyzed for poly(amino acid)s, poly(amino acid) concentrations, nucleic acids, nucleic acid concentrations, or any combination thereof. In some cases, poly(amino acid)s in the sample adsorb to distinct surfaces to form one or more adsorption layers of biomolecules. The identity of the biomolecules and concentrations thereof in the one or more adsorption layers may depend on the physical properties of the distinct surfaces and the physical properties of the biomolecules. Thus, each surface type in a panel may have differently adsorbed biomolecules due to adsorbing a different set of biomolecules, different concentrations of a particular biomolecules, or a combination thereof. Each surface type in a panel may have mutually exclusive adsorbed biomolecules or may have overlapping adsorbed biomolecules.

In some cases, panels disclosed herein can be used to identify the number of distinct biomolecules disclosed herein over a wide dynamic range in a given biological sample. For example, a panel may enrich a subset of biomolecules in a sample, which can be identified over a wide dynamic range at which the biomolecules are present in a sample (e.g., a secretome or exosome). In some cases, the enriching may be selective—e.g., biomolecules in the subset may be enriched but biomolecules outside of the subset may not enriched and/or be depleted. In some cases, the subset may comprise proteins having different post-translational modifications. For example, a first particle type in the particle panel may enrich a protein or protein group having a first post-translational modification, a second particle type in the particle panel may enrich the same protein or same protein group having a second post-translational modification, and a third particle type in the particle panel may enrich the same protein or same protein group lacking a post-translational modification. In some cases, the panel including any number of distinct particle types disclosed herein, enriches and identifies a single protein or protein group by binding different domains, sequences, or epitopes of the protein or protein group. For example, a first particle type in the particle panel may enrich a protein or protein group by binding to a first domain of the protein or protein group, and a second particle type in the particle panel may enrich the same protein or same protein group by binding to a second domain of the protein or protein group. In some cases, a panel including any number of distinct particle types disclosed herein, may enrich and identify biomolecules over a dynamic range of at least 5, 6, 7, 8, 9, 10, 15, or 20 orders of magnitude. In some cases, a panel including any number of distinct particle types disclosed herein, may enrich and identify biomolecules over a dynamic range of at most 5, 6, 7, 8, 9, 10, 15, or 20 orders of magnitude.

A panel can have more than one surface type. Increasing the number of surface types in a panel can be a method for increasing the number of proteins that can be identified in a given sample.

A particle or surface may comprise a polymer. The polymer may constitute a core material (e.g., the core of a particle may comprise a particle), a layer (e.g., a particle may comprise a layer of a polymer disposed between its core and its shell), a shell material (e.g., the surface of the particle may be coated with a polymer), or any combination thereof. Examples of polymers include any one of or any combination of polyethylenes, polycarbonates, polyanhydrides, polyhydroxyacids, polypropylfumerates, polycaprolactones, polyamides, polyacetals, polyethers, polyesters, poly(orthoesters), polycyanoacrylates, polyvinyl alcohols, polyurethanes, polyphosphazenes, polyacrylates, polymethacrylates, polycyanoacrylates, polyureas, polystyrenes, or polyamines, a polyalkylene glycol (e.g., polyethylene glycol (PEG)), a polyester (e.g., poly(lactide-co-glycolide) (PLGA), polylactic acid, or polycaprolactone), or a copolymer of two or more polymers, such as a copolymer of a polyalkylene glycol (e.g., PEG) and a polyester (e.g., PLGA). The polymer may comprise a cross link. A plurality of polymers in a particle may be phase separated, or may comprise a degree of phase separation.

Examples of lipids that can be used to form the particles or surfaces of the present disclosure include cationic, anionic, and neutrally charged lipids. For example, particles and/or surfaces can be made of any one of or any combination of dioleoylphosphatidylglycerol (DOPG), diacylphosphatidylcholine, diacylphosphatidylethanolamine, ceramide, sphingomyelin, cephalin, cholesterol, cerebrosides and diacylglycerols, dioleoylphosphatidylcholine (DOPC), dimyristoylphosphatidylcholine (DMPC), and dioleoylphosphatidylserine (DOPS), phosphatidylglycerol, cardiolipin, diacylphosphatidylserine, diacylphosphatidic acid, N-dodecanoyl phosphatidylethanolamines, N-succinyl phosphatidylethanolamines, N-glutarylphosphatidylethanolamines, lysylphosphatidylglycerols, palmitoyloleyolphosphatidylglycerol (POPG), lecithin, lysolecithin, phosphatidylethanolamine, lysophosphatidylethanolamine, dioleoylphosphatidylethanolamine (DOPE), dipalmitoyl phosphatidyl ethanolamine (DPPE), dimyristoylphosphoethanolamine (DMPE), distearoyl-phosphatidyl-ethanolamine (DSPE), palmitoyloleoyl-phosphatidylethanolamine (POPE) palmitoyloleoylphosphatidylcholine (POPC), egg phosphatidylcholine (EPC), distearoylphosphatidylcholine (DSPC), dioleoylphosphatidylcholine (DOPC), dipalmitoylphosphatidylcholine (DPPC), dioleoylphosphatidylglycerol (DOPG), dipalmitoylphosphatidylglycerol (DPPG), palmitoyloleyolphosphatidylglycerol (POPG), 16-O-monomethyl PE, 16-O-dimethyl PE, 18-1-trans PE, palmitoyloleoyl-phosphatidylethanolamine (POPE), 1-stearoyl-2-oleoyl-phosphatidyethanolamine (SOPE), phosphatidylserine, phosphatidylinositol, sphingomyelin, cephalin, cardiolipin, phosphatidic acid, cerebrosides, dicetylphosphate, cholesterol, and any combination thereof.

A particle panel may comprise a combination of particles with silica and polymer surfaces. For example, a particle panel may comprise a SPION coated with a thin layer of silica, a SPION coated with poly(dimethyl aminopropyl methacrylamide) (PDMAPMA), and a SPION coated with poly(ethylene glycol) (PEG). A particle panel consistent with the present disclosure could also comprise two or more particles selected from the group consisting of silica coated SPION, an N-(3-Trimethoxysilylpropyl) diethylenetriamine coated SPION, a PDMAPMA coated SPION, a carboxyl-functionalized polyacrylic acid coated SPION, an amino surface functionalized SPION, a polystyrene carboxyl functionalized SPION, a silica particle, and a dextran coated SPION. A particle panel consistent with the present disclosure may also comprise two or more particles selected from the group consisting of a surfactant free carboxylate particle, a carboxyl functionalized polystyrene particle, a silica coated particle, a silica particle, a dextran coated particle, an oleic acid coated particle, a boronated nanopowder coated particle, a PDMAPMA coated particle, a Poly(glycidyl methacrylate-benzylamine) coated particle, and a Poly(N-[3-(Dimethylamino)propyl]methacrylamide-co-[2-(methacryloyloxy)ethyl]dimethyl-(3-sulfopropyl)ammonium hydroxide, P(DMAPMA-co-SBMA) coated particle. A particle panel consistent with the present disclosure may comprise silica-coated particles, N-(3-Trimethoxysilylpropyl)diethylenetriamine coated particles, poly(N-(3-(dimethylamino)propyl) methacrylamide) (PDMAPMA)-coated particles, phosphate-sugar functionalized polystyrene particles, amine functionalized polystyrene particles, polystyrene carboxyl functionalized particles, ubiquitin functionalized polystyrene particles, dextran coated particles, or any combination thereof.

A particle panel consistent with the present disclosure may comprise a silica functionalized particle, an amine functionalized particle, a silicon alkoxide functionalized particle, a carboxylate functionalized particle, and a benzyl or phenyl functionalized particle. A particle panel consistent with the present disclosure may comprise a silica functionalized particle, an amine functionalized particle, a silicon alkoxide functionalized particle, a polystyrene functionalized particle, and a saccharide functionalized particle. A particle panel consistent with the present disclosure may comprise a silica functionalized particle, an N-(3-Trimethoxysilylpropyl)diethylenetriamine functionalized particle, a PDMAPMA functionalized particle, a dextran functionalized particle, and a polystyrene carboxyl functionalized particle. A particle panel consistent with the present disclosure may comprise 5 particles including a silica functionalized particle, an amine functionalized particle, a silicon alkoxide functionalized particle.

Distinct surfaces or distinct particles of the present disclosure may differ by one or more physicochemical property. The one or more physicochemical property is selected from the group consisting of: composition, size, surface charge, hydrophobicity, hydrophilicity, roughness, density surface functionalization, surface topography, surface curvature, porosity, core material, shell material, shape, and any combination thereof. The surface functionalization may comprise a macromolecular functionalization, a small molecule functionalization, or any combination thereof. A small molecule functionalization may comprise an aminopropyl functionalization, amine functionalization, boronic acid functionalization, carboxylic acid functionalization, alkyl group functionalization, N-succinimidyl ester functionalization, monosaccharide functionalization, phosphate sugar functionalization, sulfurylated sugar functionalization, ethylene glycol functionalization, streptavidin functionalization, methyl ether functionalization, trimethoxysilylpropyl functionalization, silica functionalization, triethoxylpropylaminosilane functionalization, thiol functionalization, PCP functionalization, citrate functionalization, lipoic acid functionalization, ethyleneimine functionalization. A particle panel may comprise a plurality of particles with a plurality of small molecule functionalizations selected from the group consisting of silica functionalization, trimethoxysilylpropyl functionalization, dimethylamino propyl functionalization, phosphate sugar functionalization, amine functionalization, and carboxyl functionalization.

A small molecule functionalization may comprise a polar functional group. Non-limiting examples of polar functional groups comprise carboxyl group, a hydroxyl group, a thiol group, a cyano group, a nitro group, an ammonium group, an imidazolium group, a sulfonium group, a pyridinium group, a pyrrolidinium group, a phosphonium group or any combination thereof. In some embodiments, the functional group is an acidic functional group (e.g., sulfonic acid group, carboxyl group, and the like), a basic functional group (e.g., amino group, cyclic secondary amino group (such as pyrrolidyl group and piperidyl group), pyridyl group, imidazole group, guanidine group, etc.), a carbamoyl group, a hydroxyl group, an aldehyde group and the like.

A small molecule functionalization may comprise an ionic or ionizable functional group. Non-limiting examples of ionic or ionizable functional groups comprise an ammonium group, an imidazolium group, a sulfonium group, a pyridinium group, a pyrrolidinium group, a phosphonium group. A small molecule functionalization may comprise a polymerizable functional group. Non-limiting examples of the polymerizable functional group include a vinyl group and a (meth)acrylic group. In some embodiments, the functional group is pyrrolidyl acrylate, acrylic acid, methacrylic acid, acrylamide, 2-(dimethylamino)ethyl methacrylate, hydroxyethyl methacrylate and the like.

A surface functionalization may comprise a charge. For example, a particle can be functionalized to carry a net neutral surface charge, a net positive surface charge, a net negative surface charge, or a zwitterionic surface. Surface charge can be a determinant of the types of biomolecules collected on a particle. Accordingly, optimizing a particle panel may comprise selecting particles with different surface charges, which may not only increase the number of different proteins collected on a particle panel, but also increase the likelihood of identifying a biological state of a sample. A particle panel may comprise a positively charged particle and a negatively charged particle. A particle panel may comprise a positively charged particle and a neutral particle. A particle panel may comprise a positively charged particle and a zwitterionic particle. A particle panel may comprise a neutral particle and a negatively charged particle. A particle panel may comprise a neutral particle and a zwitterionic particle. A particle panel may comprise a negative particle and a zwitterionic particle. A particle panel may comprise a positively charged particle, a negatively charged particle, and a neutral particle. A particle panel may comprise a positively charged particle, a negatively charged particle, and a zwitterionic particle. A particle panel may comprise a positively charged particle, a neutral particle, and a zwitterionic particle. A particle panel may comprise a negatively charged particle, a neutral particle, and a zwitterionic particle.

A particle may comprise a single surface such as a specific small molecule, or a plurality of surface functionalizations, such as a plurality of different small molecules. Surface functionalization can influence the composition of a particle's biomolecule corona. Such surface functionalization can include small molecule functionalization or macromolecular functionalization. A surface functionalization may be coupled to a particle material such as a polymer, metal, metal oxide, inorganic oxide (e.g., silicon dioxide), or another surface functionalization.

A surface functionalization may comprise a small molecule functionalization, a macromolecular functionalization, or a combination of two or more such functionalizations. In some cases, a macromolecular functionalization may comprise a biomacromolecule, such as a protein or a polynucleotide (e.g., a 100-mer DNA molecule). A macromolecular functionalization may comprise a protein, polynucleotide, or polysaccharide, or may be comparable in size to any of the aforementioned classes of species. In some cases, A surface functionalization may comprise an ionizable moiety. In some cases, a surface functionalization may comprise pKa of at least about 1, 2, 3, 4, 5, 6, 7, 8, 9, 10, 11, 12, 13, or 14. In some cases, a surface functionalization may comprise pKa of at most about 1, 2, 3, 4, 5, 6, 7, 8, 9, 10, 11, 12, 13, or 14. In some cases, a small molecule functionalization may comprise a small organic molecule such as an alcohol (e.g., octanol), an amine, an alkane, an alkene, an alkyne, a heterocycle (e.g., a piperidinyl group), a heteroaromatic group, a thiol, a carboxylate, a carbonyl, an amide, an ester, a thioester, a carbonate, a thiocarbonate, a carbamate, a thiocarbamate, a urea, a thiourea, a halogen, a sulfate, a phosphate, a monosaccharide, a disaccharide, a lipid, or any combination thereof. For example, a small molecule functionalization may comprise a phosphate sugar, a sugar acid, or a sulfurylated sugar.

In some cases, a macromolecular functionalization may comprise a specific form of attachment to a particle. In some cases, a macromolecule may be tethered to a particle via a linker. In some cases, the linker may hold the macromolecule close to the particle, thereby restricting its motion and reorientation relative to the particle, or may extend the macromolecule away from the particle. In some cases, the linker may be rigid (e.g., a polyolefin linker) or flexible (e.g., a nucleic acid linker). In some cases, a linker may be at least about 0.5, 1, 2, 3, 4, 5, 6, 7, 8, 9, 10, 15, 20, 25, or 30 nm in length. In some cases, a linker may be at most about 0.5, 1, 2, 3, 4, 5, 6, 7, 8, 9, 10, 15, 20, 25, or 30 nm in length. As such, a surface functionalization on a particle may project beyond a primary corona associated with the particle. In some cases, a surface functionalization may also be situated beneath or within a biomolecule corona that forms on the particle surface. In some cases, a macromolecule may be tethered at a specific location, such as at a protein's C-terminus, or may be tethered at a number of possible sites. For example, a peptide may be covalent attached to a particle via any of its surface exposed lysine residues.

In some cases, a particle may be contacted with a biological sample (e.g., a biofluid) to form a biomolecule corona. In some cases, a biomolecule corona may comprise at least two biomolecules that do not share a common binding motif. The particle and biomolecule corona may be separated from the biological sample, for example by centrifugation, magnetic separation, filtration, or gravitational separation. The particle types and biomolecule corona may be separated from the biological sample using a number of separation techniques. Non-limiting examples of separation techniques include comprises magnetic separation, column-based separation, filtration, spin column-based separation, centrifugation, ultracentrifugation, density or gradient-based centrifugation, gravitational separation, or any combination thereof. A protein corona analysis may be performed on the separated particle and biomolecule corona. A protein corona analysis may comprise identifying one or more proteins in the biomolecule corona, for example by mass spectrometry. In some cases, a single particle type may be contacted with a biological sample. In some cases, a plurality of particle types may be contacted to a biological sample. In some cases, the plurality of particle types may be combined and contacted to the biological sample in a single sample volume. In some cases, the plurality of particle types may be sequentially contacted to a biological sample and separated from the biological sample prior to contacting a subsequent particle type to the biological sample. In some cases, adsorbed biomolecules on the particle may have compressed (e.g., smaller) dynamic range compared to a given original biological sample.

In some cases, the particles of the present disclosure may be used to serially interrogate a sample by incubating a first particle type with the sample to form a biomolecule corona on the first particle type, separating the first particle type, incubating a second particle type with the sample to form a biomolecule corona on the second particle type, separating the second particle type, and repeating the interrogating (by incubation with the sample) and the separating for any number of particle types. In some cases, the biomolecule corona on each particle type used for serial interrogation of a sample may be analyzed by protein corona analysis. The biomolecule content of the supernatant may be analyzed following serial interrogation with one or more particle types.

In some cases, a method of the present disclosure may identify a large number of unique biomolecules (e.g., proteins) in a biological sample (e.g., a biofluid). In some cases, a surface disclosed herein may be incubated with a biological sample to adsorb at least 1000, 2000, 3000, 4000, 5000, 6000, 7000, 8000, 9000, or 10000 unique biomolecules. In some cases, a surface disclosed herein may be incubated with a biological sample to adsorb at most 1000, 2000, 3000, 4000, 5000, 6000, 7000, 8000, 9000, or 10000 unique biomolecules. In some cases, a surface disclosed herein may be incubated with a biological sample to adsorb at least 1000, 2000, 3000, 4000, 5000, 6000, 7000, 8000, 9000, or 10000 unique biomolecule groups. In some cases, a surface disclosed herein may be incubated with a biological sample to adsorb at most 1000, 2000, 3000, 4000, 5000, 6000, 7000, 8000, 9000, or 10000 unique biomolecule groups. In some cases, several different types of surfaces can be used, separately or in combination, to identify large numbers of proteins in a particular biological sample. In other words, surfaces can be multiplexed in order to bind and identify large numbers of biomolecules in a biological sample.

In some cases, a method of the present disclosure may identify a large number of unique proteoforms in a biological sample. In some cases, a method may identify at least about 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, or 10000 unique proteoforms. In some cases, a method may identify at most about 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, or 10000 unique proteoforms. In some cases, a surface disclosed herein may be incubated with a biological sample to adsorb at least 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, or 10000 unique proteoforms. In some cases, a surface disclosed herein may be incubated with a biological sample to adsorb at most 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, or 10000 unique proteoforms. In some cases, several different types of surfaces can be used, separately or in combination, to identify large numbers of proteins in a particular biological sample. In other words, surfaces can be multiplexed in order to bind and identify large numbers of biomolecules in a biological sample.

Biomolecules collected on particles may be subjected to further analysis. In some cases, a method may comprise collecting a biomolecule corona or a subset of biomolecules from a biomolecule corona. In some cases, the collected biomolecule corona or the collected subset of biomolecules from the biomolecule corona may be subjected to further particle-based analysis (e.g., particle adsorption). In some cases, the collected biomolecule corona or the collected subset of biomolecules from the biomolecule corona may be purified or fractionated (e.g., by a chromatographic method). In some cases, the collected biomolecule corona or the collected subset of biomolecules from the biomolecule corona may be analyzed (e.g., by mass spectrometry).

In some cases, the panels disclosed herein can be used to identify a number of proteins, peptides, protein groups, or protein classes using a protein analysis workflow described herein (e.g., a protein corona analysis workflow). In some cases, protein analysis may comprise contacting a sample to distinct surface types (e.g., a particle panel), forming adsorbed biomolecule layers on the distinct surface types, and identifying the biomolecules in the adsorbed biomolecule layers (e.g., by mass spectrometry). Feature intensities, as disclosed herein, may refer to the intensity of a discrete spike (“feature”) seen on a plot of mass to charge ratio versus intensity from a mass spectrometry run of a sample. In some cases, these features can correspond to variably ionized fragments of peptides and/or proteins. In some cases, using the data analysis methods described herein, feature intensities can be sorted into protein groups. In some cases, protein groups may refer to two or more proteins that are identified by a shared peptide sequence. In some cases, a protein group can refer to one protein that is identified using a unique identifying sequence. For example, if in a sample, a peptide sequence is assayed that is shared between two proteins (Protein 1: XYZZX and Protein 2: XYZYZ), a protein group could be the “XYZ protein group” having two members (protein 1 and protein 2). In some cases, if the peptide sequence is unique to a single protein (Protein 1), a protein group could be the “ZZX” protein group having one member (Protein 1). In some cases, each protein group can be supported by more than one peptide sequence. In some cases, protein detected or identified according to the instant disclosure can refer to a distinct protein detected in the sample (e.g., distinct relative other proteins detected using mass spectrometry). In some cases, analysis of proteins presents in distinct coronas corresponding to the distinct surface types in a panel yields a high number of feature intensities. In some cases, this number decreases as feature intensities are processed into distinct peptides, further decreases as distinct peptides are processed into distinct proteins, and further decreases as peptides are grouped into protein groups (two or more proteins that share a distinct peptide sequence).

In some cases, the methods disclosed herein include isolating one or more particle types from a sample or from more than one sample (e.g., a biological sample or a serially interrogated sample). The particle types can be rapidly isolated or separated from the sample using a magnet. Moreover, multiple samples that are spatially isolated can be processed in parallel. In some cases, the methods disclosed herein provide for isolating or separating a particle type from unbound protein in a sample. In some cases, a particle type may be separated by a variety of approaches, including but not limited to magnetic separation, centrifugation, filtration, or gravitational separation. In some cases, particle panels may be incubated with a plurality of spatially isolated samples, wherein each spatially isolated sample is in a well in a well plate (e.g., a 96-well plate). In some cases, the particle in each of the wells of the well plate can be separated from unbound protein present in the spatially isolated samples by placing the entire plate on a magnet. In some cases, this simultaneously pulls down the superparamagnetic particles in the particle panel. In some cases, the supernatant in each sample can be removed to remove the unbound protein. In some cases, these steps (incubate, pull down) can be repeated to effectively wash the particles, thus removing residual background unbound protein that may be present in a sample.

In some cases, the systems and methods disclosed herein may also elucidate protein classes or interactions of the protein classes. In some cases, a protein class may comprise a set of proteins that share a common function (e.g., amine oxidases or proteins involved in angiogenesis); proteins that share common physiological, cellular, or subcellular localization (e.g., peroxisomal proteins or membrane proteins); proteins that share a common cofactor (e.g., heme or flavin proteins); proteins that correspond to a particular biological state (e.g., hypoxia related proteins); proteins containing a particular structural motif (e.g., a cupin fold); proteins that are functionally related (e.g., part of a same metabolic pathway); or proteins bearing a post-translational modification (e.g., ubiquitinated or citrullinated proteins). In some cases, a protein class may contain at least 2 proteins, 5 proteins, 10 proteins, 20 proteins, 40 proteins, 60 proteins, 80 proteins, 100 proteins, 150 proteins, 200 proteins, or more.

In some cases, the proteomic data of the biological sample can be identified, measured, and quantified using a number of different analytical techniques. For example, proteomic data can be generated using SDS-PAGE or any gel-based separation technique. In some cases, peptides and proteins can also be identified, measured, and quantified using an immunoassay, such as ELISA. In some cases, proteomic data can be identified, measured, and quantified using mass spectrometry, high performance liquid chromatography, LC-MS/MS, Edman Degradation, immunoaffinity techniques, and other protein separation techniques.

In some cases, an assay may comprise protein collection of particles, protein digestion, and mass spectrometric analysis (e.g., MS, LC-MS, LC-MS/MS). In some cases, the digestion may comprise chemical digestion, such as by cyanogen bromide or 2-Nitro-5-thiocyanatobenzoic acid (NTCB). In some cases, the digestion may comprise enzymatic digestion, such as by trypsin or pepsin. In some cases, the digestion may comprise enzymatic digestion by a plurality of proteases. In some cases, the digestion may comprise a protease selected from among the group consisting of trypsin, chymotrypsin, Glu C, Lys C, elastase, subtilisin, proteinase K, thrombin, factor X, Arg C, papaine, Asp N, thermolysine, pepsin, aspartyl protease, cathepsin D, zinc mealloprotease, glycoprotein endopeptidase, proline, aminopeptidase, prenyl protease, caspase, kex2 endoprotease, or any combination thereof. In some cases, the digestion may cleave peptides at random positions. In some cases, the digestion may cleave peptides at a specific position (e.g., at methionines) or sequence (e.g., glutamate-histidine-glutamate). In some cases, the digestion may enable similar proteins to be distinguished. For example, an assay may resolve 8 distinct proteins as a single protein group with a first digestion method, and as 8 separate proteins with distinct signals with a second digestion method. In some cases, the digestion may generate an average peptide fragment length of 8 to 15 amino acids. In some cases, the digestion may generate an average peptide fragment length of 12 to 18 amino acids. In some cases, the digestion may generate an average peptide fragment length of 15 to 25 amino acids. In some cases, the digestion may generate an average peptide fragment length of 20 to 30 amino acids. In some cases, the digestion may generate an average peptide fragment length of 30 to 50 amino acids.

In some cases, an assay may rapidly generate biological samples for analysis. In some cases, the biological samples may comprise proteolytic peptides. In some cases, beginning with an input biological sample (e.g., a buccal or nasal smear, plasma, secretome, or tissue), a method of the present disclosure may generate the biological samples in less than about 1, 2, 3, 4, 5, 6, 7, 8, 12, 16, 20, 24, or 48 hours. In some cases, beginning with an input biological sample (e.g., a buccal or nasal smear, plasma, secretome, or tissue), a method of the present disclosure may generate the biological samples in less than about 1, 2, 3, 4, 5, 6, 7, 8, 12, 16, 20, 24, or 48 hours.

In some cases, an assay may rapidly generate and analyze proteomic data. In some cases, beginning with an input biological sample (e.g., a buccal or nasal smear, plasma, or tissue), a method of the present disclosure may generate and obtain proteomic data in less than about 1, 2, 3, 4, 5, 6, 7, 8, 12, 16, 20, 24, or 48 hours. In some cases, beginning with an input biological sample (e.g., a buccal or nasal smear, plasma, or tissue), a method of the present disclosure may generate and analyze proteomic data in less than about 1, 2, 3, 4, 5, 6, 7, 8, 12, 16, 20, 24, or 48 hours. In some cases, the analyzing may comprise identifying a protein group. In some cases, the analyzing may comprise identifying a protein class. In some cases, the analyzing may comprise quantifying an abundance of a biomolecule, a peptide, a protein, protein group, or a protein class. In some cases, the analyzing may comprise identifying a ratio of abundances of two biomolecules, peptides, proteins, protein groups, or protein classes. In some cases, the analyzing may comprise identifying a biological state.

An example of a particle type of the present disclosure may be a carboxylate (Citrate) superparamagnetic iron oxide nanoparticle (SPION), a phenol-formaldehyde coated SPION, a silica-coated SPION, a polystyrene coated SPION, a carboxylated poly(styrene-co-methacrylic acid) coated SPION, a N-(3-Trimethoxysilylpropyl)diethylenetriamine coated SPION, a poly(N-(3-(dimethylamino)propyl) methacrylamide) (PDMAPMA)-coated SPION, a 1,2,4,5-Benzenetetracarboxylic acid coated SPION, a poly(Vinylbenzyltrimethylammonium chloride) (PVBTMAC) coated SPION, a carboxylate, PAA coated SPION, a poly(oligo(ethylene glycol) methyl ether methacrylate) (POEGMA)-coated SPION, a carboxylate microparticle, a polystyrene carboxyl functionalized particle, a carboxylic acid coated particle, a silica particle, a carboxylic acid particle of about 150 nm in diameter, an amino surface microparticle of about 0.4-0.6 μm in diameter, a silica amino functionalized microparticle of about 0.1-0.39 μm in diameter, a Jeffamine surface particle of about 0.1-0.39 μm in diameter, a polystyrene microparticle of about 2.0-2.9 μm in diameter, a silica particle, a carboxylated particle with an original coating of about 50 nm in diameter, a particle coated with a dextran based coating of about 0.13 μm in diameter, or a silica silanol coated particle with low acidity. In some cases, a particle may lack functionalized specific binding moieties for specific binding on its surface. In some cases, a particle may lack functionalized proteins for specific binding on its surface. In some cases, a surface functionalized particle does not comprise an antibody or a T cell receptor, a chimeric antigen receptor, a receptor protein, or a variant or fragment thereof. In some cases, the ratio between surface area and mass can be a determinant of a particle's properties. A particle of the present disclosure may be a nanoparticle. A nanoparticle of the present disclosure may be from about 10 nm to about 1000 nm in diameter. For example, the nanoparticles disclosed herein can be at least 10 nm, at least 100 nm, at least 200 nm, at least 300 nm, at least 400 nm, at least 500 nm, at least 600 nm, at least 700 nm, at least 800 nm, at least 900 nm, from 10 nm to 50 nm, from 50 nm to 100 nm, from 100 nm to 150 nm, from 150 nm to 200 nm, from 200 nm to 250 nm, from 250 nm to 300 nm, from 300 nm to 350 nm, from 350 nm to 400 nm, from 400 nm to 450 nm, from 450 nm to 500 nm, from 500 nm to 550 nm, from 550 nm to 600 nm, from 600 nm to 650 nm, from 650 nm to 700 nm, from 700 nm to 750 nm, from 750 nm to 800 nm, from 800 nm to 850 nm, from 850 nm to 900 nm, from 100 nm to 300 nm, from 150 nm to 350 nm, from 200 nm to 400 nm, from 250 nm to 450 nm, from 300 nm to 500 nm, from 350 nm to 550 nm, from 400 nm to 600 nm, from 450 nm to 650 nm, from 500 nm to 700 nm, from 550 nm to 750 nm, from 600 nm to 800 nm, from 650 nm to 850 nm, from 700 nm to 900 nm, or from 10 nm to 900 nm in diameter. A nanoparticle may be less than 1000 nm in diameter. A particle of the present disclosure may be a microparticle. A microparticle may be a particle that is from about 1 μm to about 1000 μm in diameter. For example, the microparticles disclosed here can be at least 1 μm, at least 10 μm, at least 100 μm, at least 200 μm, at least 300 μm, at least 400 μm, at least 500 μm, at least 600 μm, at least 700 μm, at least 800 μm, at least 900 μm, from 10 μm to 50 μm, from 50 μm to 100 μm, from 100 μm to 150 μm, from 150 μm to 200 μm, from 200 μm to 250 μm, from 250 μm to 300 μm, from 300 μm to 350 μm, from 350 μm to 400 μm, from 400 μm to 450 μm, from 450 μm to 500 μm, from 500 μm to 550 μm, from 550 μm to 600 μm, from 600 μm to 650 μm, from 650 μm to 700 μm, from 700 μm to 750 μm, from 750 μm to 800 μm, from 800 μm to 850 μm, from 850 μm to 900 μm, from 100 μm to 300 μm, from 150 μm to 350 μm, from 200 μm to 400 μm, from 250 μm to 450 μm, from 300 μm to 500 μm, from 350 μm to 550 μm, from 400 μm to 600 μm, from 450 μm to 650 μm, from 500 μm to 700 μm, from 550 μm to 750 μm, from 600 μm to 800 μm, from 650 μm to 850 μm, from 700 μm to 900 μm, or from 10 μm to 900 μm in diameter. A microparticle may be less than 1000 μm in diameter. The particles disclosed herein can have surface area to mass ratios of 3 to 30 cm²/mg, 5 to 50 cm²/mg, 10 to 60 cm²/mg, 15 to 70 cm²/mg, 20 to 80 cm²/mg, 30 to 100 cm²/mg, 35 to 120 cm²/mg, 40 to 130 cm²/mg, 45 to 150 cm²/mg, 50 to 160 cm²/mg, 60 to 180 cm²/mg, 70 to 200 cm²/mg, 80 to 220 cm²/mg, 90 to 240 cm²/mg, 100 to 270 cm²/mg, 120 to 300 cm²/mg, 200 to 500 cm²/mg, 10 to 300 cm²/mg, 1 to 3000 cm²/mg, 20 to 150 cm²/mg, 25 to 120 cm²/mg, or from 40 to 85 cm²/mg. Small particles (e.g., with diameters of 50 nm or less) can have significantly higher surface area to mass ratios, stemming in part from the higher order dependence on diameter by mass than by surface area. In some cases (e.g., for small particles), the particles can have surface area to mass ratios of 200 to 1000 cm²/mg, 500 to 2000 cm²/mg, 1000 to 4000 cm²/mg, 2000 to 8000 cm²/mg, or 4000 to 10000 cm²/mg. In some cases (e.g., for large particles), the particles can have surface area to mass ratios of 1 to 3 cm²/mg, 0.5 to 2 cm²/mg, 0.25 to 1.5 cm²/mg, or 0.1 to 1 cm²/mg. A particle may comprise a wide array of physical properties. A physical property of a particle may include composition, size, surface charge, hydrophobicity, hydrophilicity, amphipathicity, surface functionality, surface topography, surface curvature, porosity, core material, shell material, shape, zeta potential, and any combination thereof. A particle may have a core-shell structure. In some cases, a core material may comprise metals, polymers, magnetic materials, paramagnetic materials, oxides, and/or lipids. In some cases, a shell material may comprise metals, polymers, magnetic materials, oxides, and/or lipids.

### Proteomic Information

In some cases, proteomic information or data can refer to information about substances comprising a peptide and/or a protein component. In some cases, proteomic information may comprise primary structure information, secondary structure information, tertiary structure information, or quaternary information about the peptide or a protein. In some cases, proteomic information may comprise information about protein-ligand interactions, wherein a ligand may comprise any one of various biological molecules and substances that may be found in living organisms, such as, nucleotides, nucleic acids, amino acids, peptides, proteins, monosaccharides, polysaccharides, lipids, phospholipids, hormones, or any combination thereof.

In some cases, proteomic information may comprise information about a single cell, a tissue, an organ, a system of tissues and/or organs (such as cardiovascular, respiratory, digestive, or nervous systems), or an entire multicellular organism. In some cases, proteomic information may comprise information about an individual (e.g., an individual human being or an individual bacterium), or a population of individuals (e.g., human beings with diagnosed with cancer or a colony of bacteria). Proteomic information may comprise information from various forms of life, including forms of life from the Archaea, the Bacteria, the Eukarya, the Protozoa, the Chromista, the Plantae, the Fungi, or from the Animalia. In some cases, proteomic information may comprise information from viruses.

In some cases, proteomic information may comprise information relating exons and/or introns. In some cases, proteomic information may comprise information regarding variations in the primary structure, variations in the secondary structure, variations in the tertiary structure, or variations in the quaternary structure of peptides and/or proteins. In some cases, proteomic information may comprise information regarding variations in the expression of exons, including alternative splicing variations, structural variations, or both. In some cases, proteomic information may comprise conformation information, post-translational modification information, chemical modification information (e.g., phosphorylation), cofactor (e.g., salts or other regulatory chemicals) association information, or substrate association information of peptides and/or proteins.

In some cases, proteomic information may comprise information related to various proteoforms in a sample. In some cases, a proteomic information may comprise information related to peptide variants, protein variants, or both. In some cases, a proteomic information may comprise information related to splicing variants, allelic variants, post-translation modification variants, or any combination thereof. In some cases, peptide variants or protein variants may comprise a post-translation modification. In some cases, the post-translational modification comprises acylation, alkylation, prenylation, flavination, amination, deamination, carboxylation, decarboxylation, nitrosylation, halogenation, sulfurylation, glutathionylation, oxidation, oxygenation, reduction, ubiquitination, SUMOylation, neddylation, myristoylation, palmitoylation, isoprenylation, farnesylation, geranylgeranylation, glypiation, glycosylphosphatidylinositol anchor formation, lipoylation, heme functionalization, phosphorylation, phosphopantetheinylation, retinylidene Schiff base formation, diphthamide formation, ethanolamine phosphoglycerol functionalization, hypusine formation, beta-Lysine addition, acetylation, formylation, methylation, amidation, amide bond formation, butyrylation, gamma-carboxylation, glycosylation, polysialylation, malonylation, hydroxylation, iodination, nucleotide addition, phosphate ester formation, phosphoramidate formation, adenylation, uridylylation, propionylation, pyroglutamate formation, gluthathionylation, sulfenylation, sulfinylation, sulfonylation, succinylation, sulfation, glycation, carbonylation, isopeptide bond formation, biotinylation, carbamylation, oxidation, pegylation, citrullination, deamidation, eliminylation, disulfide bond formation, proteolytic cleavage, isoaspartate formation, racemization, protein splicing, chaperon-assisted folding, or any combination thereof.

### Types of Data

Methods, systems, and algorithms of the present disclosure my ingest, operate on, analyze, and/or output one or more datasets as described herein. In some embodiments, the one or more datasets comprises mass spectrometry data. In some embodiments, the mass spectrometry data are generated from a mass spectrometry assay of a biological sample as described herein. In some embodiments, the mass spectrometry data are derived from a liquid chromatography-mass spectrometry (LC-MS) assay. In some embodiments, the mass spectrometry data are derived from a targeted mass spectrometry assay. In some embodiments, the mass spectrometry data are derived from an untargeted mass spectrometry assay. In some embodiments, the mass spectrometry data are derived from a tandem mass spectrometry (e.g., MS/MS) assay. In some embodiments, the mass spectrometry data are derived from a liquid chromatography-tandem mass spectrometry (LC-MS/MS) data. In some embodiments, the mass spectrometry data comprise one or more MS1 spectra. In some embodiments, the mass spectrometry data comprise one or more MS2 spectra. In some embodiments, the mass spectrometry data comprises retention time data for one or more analytes. In some embodiments, the mass spectrometry data is acquired by Data-Independent Acquisition (DIA). In some embodiments, the mass spectrometry data is acquired by Data-Dependent Acquisition (DDA).

In some embodiments, the mass spectrometry data comprises a multidimensional dataset (e.g., two, three, four, or more dimensions) characterizing spectrum intensities. The spectrum intensities may be partitioned into bins along a plurality of axes to generate an image map (e.g., image data) characterizing the mass spectrometry data. In some embodiments, the axes comprise retention time and m/z ratio. The data may span any range of retention times and m/z ratios to form, for example, a two-dimensional image. For example, the data may span a retention time of at least 10 minutes and an m/z range of at least 500 m/z. In some embodiments, the axes comprise retention time and ion mobility.

In some embodiments, the mass spectrometry data are subjected to one or more (pre)processing operations to generate the image map or a version of the image map suitable for use with the methods, systems, and algorithms disclosed herein. Processing operations may include, without limitation, standardization or normalization. The one or more processing steps may, for example, discard data which contain spurious values or contain very few observations. The one or more processing steps may further or alternatively standardize the encoding of data values. Different input datasets may have the same parameter value encoded in different ways, depending on the source of the dataset. For example, ‘900’, ‘900.0’, ‘904’, ‘904.0’, ‘−1’, ‘−1.0’, ‘None’, and ‘NaN’ may all encode for a “missing” parameter value. The one or more processing steps may recognize the encoding variation for the same value and standardize the dataset to have a uniform encoding for a given parameter value. The processing step may thus reduce irregularities in the input data for downstream use. The one or more data sets may normalize parameter values. For example, numerical data may be scaled, whitened, colored, decorrelated, or standardized. For example, data may be scaled or shifted to lie in a particular interval (e.g., [0,1] or [−1, 1]) and/or have correlations removed. In some embodiments, data is not subjected to a processing operation.

In some embodiments, image data is subjected to one or more image processing operations. The image processing operation may comprise an image filtering operation, an image compression operation, an image segmentation operation, an image concatenation operation, or an image detection operation. The image processing operation may filter, transform, scale, rotate, mirror, shear, combine, compress, segment, concatenate, extract features from, and/or smooth an image prior to downstream processing (e.g., by methods, systems, or algorithms of the disclosure). In some embodiments, the image processing operation comprises an image filtering operation. In some embodiments, the image processing operation comprises an image compression operation. In some embodiments, the image processing operation comprises an image segmentation operation. In some embodiments, the image processing operation comprises an image concatenation operation. In some embodiments, the image processing operation comprises or an image detection operation.

In some embodiments, the image processing operation comprises a downsampling operation. As a non-limiting example, the max spectrum data may be downsampled by selecting the maximum value within each bin to produce a 1300×1300 PNG encoded image having approximately 50 pixels per minute for a 4-30 minute retention and 1 pixel for each m/z over a range of 300 m/z to 1600 m/z. In some embodiments, each dimension of the image may be downsampled to be less than 8000 pixels, less than 4000 pixels, less than 3000 pixels, less than 1500 pixels, less than 1000 pixels, or less than 500 pixels. In some embodiments, each dimension of the image may be downsampled to be more than 200 pixels, more than 500 pixels, more than 1000 pixels, or more than 1500 pixels. In some embodiments, each dimension of the image may be downsampled to be 200 to 4000 pixels. In some embodiments, the image may be downsampled to have a total number of pixels less than 100 million pixels, less than 35 million pixels, less than 10 million pixels, less than 4 million pixels, less than 2 million pixels, or less than 1 million pixels. In some embodiments, the image may be downsampled to have a total number of pixels of more than 50,000 pixels, more than 250,000 pixels, more than 750,000 pixels, and more than 1 million pixels. In some embodiments, the image may be downsampled to have a total number of pixels 50,000 to 10 million pixels. The method of downsampling is not particularly limited and may be, for example, max pooling, nearest neighbor downsampling, bilinear downsampling, bicubic downsampling, gaussian downsampling, or any combination thereof. In some embodiments, the downsampling may produce about 2 pixels or less for each second of retention time sampled. In some embodiments, the downsampling may produce about 2 pixels or less for each m/z sampled.

In some embodiments, data as described herein may comprise an experimental parameter or set of experimental parameters associated with a mass spectrometry dataset. In some embodiments, the experimental parameter comprises assay volume, temperature, humidity, position, chromatographic conditions, gradient length, column type, column packing material, LC system pressure, ionizer type, detector type, inner diameter, peak capacity, flow rate, buffer type, pH, temperature, presence of a contamination, or any combination thereof. In some embodiments, the experimental comprises a surface or surface functionalization as described herein. In some embodiments, the experimental parameter comprises a physicochemical property associated with the surface. In some embodiments, the physicochemical property comprises size, surface charge, zeta potential, hydrophobicity, hydrophilicity, surface functionalization, surface topography, shape, or any combination thereof. In some embodiments, the experimental parameter comprises a parameter associated with a biological sample or biological samples from which a mass spectrum or other mass spectrometry data is derived. In some embodiments, the experimental parameter comprises a parameter or characteristic associated with a subject or subjects from which the biological sample(s) is (are) derived.

Methods, systems, and algorithms of the present disclosure may be configured to associate one type of data with another and/or to predict a likelihood of an association with one type of data and another. In some embodiments, the association comprises a classification of an experimental parameter. In some embodiments, methods, systems, and algorithms of the present disclosure may be configured to classify one type of data between or among a plurality of categories associated with another type of data.

### Trained Algorithms

In some embodiments, mass spectrometry datasets can be processed using a trained algorithm. The trained algorithm may comprise a machine learning algorithm. The trained algorithm may comprise a supervised machine learning algorithm. The trained algorithm may comprise an unsupervised machine learning algorithm. In some embodiments, the machine learning algorithm comprises a single machine learning algorithm. In some embodiments, the machine learning algorithm comprises a plurality of machine learning algorithms. The trained algorithm may comprise a classification and regression tree (CART) algorithm. The supervised machine learning algorithm may comprise, for example, a Random Forest, a support vector machine (SVM), a neural network, or a deep learning algorithm.

In some embodiments, the method of determining a set of biomolecules associated with the disease or disorder and/or disease state can include the analysis of the biomolecule corona of at least two samples. This determination, analysis or statistical classification can be performed by methods, including, but not limited to, for example, a wide variety of supervised and unsupervised data analysis, machine learning, deep learning, and clustering approaches including hierarchical cluster analysis (HCA), principal component analysis (PCA), Partial least squares Discriminant Analysis (PLS-DA), random forest, logistic regression, decision trees, support vector machine (SVM), k-nearest neighbors, naive Bayes, linear regression, polynomial regression, SVM for regression, K-means clustering, and hidden Markov models, among others. In other words, the biomolecules in the corona of each sample are compared/analyzed with each other to determine with statistical significance what patterns are common between the individual corona to determine a set of biomolecules that is associated with the disease or disorder or disease state.

In some embodiments, machine learning algorithms can be used to construct models that accurately assign class labels to examples based on the input features that describe the example. In some case it may be advantageous to employ machine learning and/or deep learning approaches for the methods described herein. For example, machine learning can be used to associate the biomolecule corona with various disease states (e.g. no disease, precursor to a disease, having early or late stage of the disease, etc.). For example, in some embodiments, one or more machine learning algorithms can be employed in connection with the methods disclosed hereinto analyze data detected and obtained by the biomolecule corona and sets of biomolecules derived therefrom. For example, machine learning can be coupled with genomic and proteomic information obtained using the methods described herein to determine not only if a subject has a pre-stage of cancer, cancer or does not have or develop cancer, and also to distinguish the type of cancer.

In some embodiments, a machine learning algorithm of a method or system as described herein utilizes one or more neural networks. In some cases, a neural network is a type of computational system that can learn the relationships between an input dataset and a target dataset. A neural network may be a software representation of a human neural system (e.g., cognitive system), intended to capture “learning” and “generalization” abilities as used by a human. In some embodiments, the machine learning algorithm comprises a neural network comprising a CNN. Non-limiting examples of structural components of machine learning algorithms described herein include: CNNs, recurrent neural networks, dilated CNNs, fully-connected neural networks, deep generative models, attention-based models (e.g., transformers), and Boltzmann machines.

In some embodiments, a neural network comprises a series of layers termed “neurons.” In some embodiments, a neural network comprises an input layer, to which data is presented; one or more internal, and/or “hidden”, layers; and an output layer. A neuron may be connected to neurons in other layers via connections that have weights, which are parameters that control the strength of the connection. The number of neurons in each layer may be related to the complexity of the problem to be solved. The minimum number of neurons required in a layer may be determined by the problem complexity, and the maximum number may be limited by the ability of the neural network to generalize. The input neurons may receive data being presented and then transmit that data to the first hidden layer through connections' weights, which are modified during training. The first hidden layer may process the data and transmit its result to the next layer through a second set of weighted connections. Each subsequent layer may “pool” the results from the previous layers into more complex relationships. In addition, whereas conventional software programs require writing specific instructions to perform a function, neural networks are programmed by training them with a known sample set and allowing them to modify themselves during (and after) training so as to provide a desired output such as an output value. After training, when a neural network is presented with new input data, it is configured to generalize what was “learned” during training and apply what was learned from training to the new previously unseen input data in order to generate an output associated with that input.

In some embodiments, the neural network comprises artificial neural networks (ANNs). ANNs may be machine learning algorithms that may be trained to map an input dataset to an output dataset, where the ANN comprises an interconnected group of nodes organized into multiple layers of nodes. For example, the ANN architecture may comprise at least an input layer, one or more hidden layers, and an output layer. The ANN may comprise any total number of layers, and any number of hidden layers, where the hidden layers function as trainable feature extractors that allow mapping of a set of input data to an output value or set of output values. As used herein, a deep learning algorithm (such as a deep neural network (DNN)) is an ANN comprising a plurality of hidden layers, e.g., two or more hidden layers. Each layer of the neural network may comprise a number of nodes (or “neurons”). A node receives input that comes either directly from the input data or the output of nodes in previous layers, and performs a specific operation, e.g., a summation operation. A connection from an input to a node is associated with a weight (or weighting factor). The node may sum up the products of all pairs of inputs and their associated weights. The weighted sum may be offset with a bias. The output of a node or neuron may be gated using a threshold or activation function. The activation function may be a linear or non-linear function. The activation function may be, for example, a rectified linear unit (ReLU) activation function, a Leaky ReLU activation function, or other function such as a saturating hyperbolic tangent, identity, binary step, logistic, arctan, softsign, parametric rectified linear unit, exponential linear unit, softplus, bent identity, softexponential, sinusoid, sinc, Gaussian, or sigmoid function, or any combination thereof.

The weighting factors, bias values, and threshold values, or other computational parameters of the neural network, may be “taught” or “learned” in a training phase using one or more sets of training data. For example, the parameters may be trained using the input data from a training dataset and a parameter optimization method (e.g., gradient descent based on a backward propagation operation) so that the output value(s) that the ANN computes are consistent with the examples included in the training dataset.

The number of nodes used in the input layer of the ANN or DNN may be at least about 10, 50, 100, 200, 300, 400, 500, 600, 700, 800, 900, 1000, 2000, 3000, 4000, 5000, 6000, 7000, 8000, 9000, 10,000, 20,000, 30,000, 40,000, 50,000, 60,000, 70,000, 80,000, 90,000, 100,000, or greater. In other instances, the number of nodes used in the input layer may be at most about 100,000, 90,000, 80,000, 70,000, 60,000, 50,000, 40,000, 30,000, 20,000, 10,000, 9000, 8000, 7000, 6000, 5000, 4000, 3000, 2000, 1000, 900, 800, 700, 600, 500, 400, 300, 200, 100, 50, 10, or less. In some instances, the total number of layers used in the ANN or DNN (including input and output layers) may be at least about 3, 4, 5, 10, 15, 20, or greater. In other instances, the total number of layers may be at most about 20, 15, 10, 5, 4, 3, or less.

In some instances, the total number of learnable or trainable parameters, e.g., weighting factors, biases, or threshold values, used in the ANN or DNN may be at least about 10, 50, 100, 200, 300, 400, 500, 600, 700, 800, 900, 1000, 2000, 3000, 4000, 5000, 6000, 7000, 8000, 9000, 10,000, 20,000, 30,000, 40,000, 50,000, 60,000, 70,000, 80,000, 90,000, 100,000, or greater. In other instances, the number of learnable parameters may be at most about 100,000, 90,000, 80,000, 70,000, 60,000, 50,000, 40,000, 30,000, 20,000, 10,000, 9000, 8000, 7000, 6000, 5000, 4000, 3000, 2000, 1000, 900, 800, 700, 600, 500, 400, 300, 200, 100, 50, 10, or less.

In some embodiments of a machine learning algorithm as described herein, a machine learning algorithm comprises a neural network such as a deep CNN. In some embodiments in which a CNN is used, the network is constructed with any number of convolutional layers, dilated layers or fully-connected layers. In some embodiments, the number of convolutional layers is between 1-10 and the dilated layers between 0-10. In some embodiments, the total number of convolutional layers (including input and output layers) may be at least about 1, 2, 3, 4, 5, 10, 15, 20, or greater. In some embodiments, the total number of dilated layers may be at least about 1, 2, 3, 4, 5, 10, 15, 20, or greater. In some embodiments, the total number of convolutional layers is at most about 20, 15, 10, 5, 4, 3, or less. In some embodiments, the total number of dilated layers may be at most about 20, 15, 10, 5, 4, 3, or less. In some embodiments, the number of convolutional layers is between 1-10 and the fully-connected layers between 0-10. In some embodiments, the total number of convolutional layers (including input and output layers) may be at least about 1, 2, 3, 4, 5, 10, 15, 20, or greater, and the total number of fully-connected layers may be at least about 1, 2, 3, 4, 5, 10, 15, 20, or greater. In some embodiments, the total number of convolutional layers may be at most about 20, 15, 10, 5, 4, 3, 2, 1, or less, and the total number of fully-connected layers may be at most about 20, 15, 10, 5, 4, 3, 2, 1, or less.

The CNN may comprise an input, an output layer, and multiple hidden layers. The hidden layers of a CNN may comprise convolutional layers, pooling layers, fully-connected layers and normalization layers. The layers may be organized in 3 dimensions: width, height, and depth.

The convolutional layers may apply a convolution operation to the input and pass results of the convolution operation to the next layer. For processing images, the convolution operation may reduce the number of free parameters, allowing the network to be deeper with fewer parameters. In neural networks, each neuron may receive input from some number of locations in the previous layer. In a convolutional layer, neurons may receive input from only a restricted subarea of the previous layer. The convolutional layer's parameters may comprise a set of learnable filters. The learnable filters may have a small receptive field and extend through the full depth of the input volume. During the forward pass, each filter may be convolved across the width and height of the input volume, compute the dot product between the entries of the filter and the input, and produce a two-dimensional activation map of that filter. As a result, the network may learn filters that activate when it detects some specific type of feature at some spatial position in the input.

In some embodiments, the pooling layers comprise global pooling layers. The global pooling layers may combine the outputs of neuron clusters at one layer into a single neuron in the next layer. In some embodiments, the global pooling layers may comprise max pooling layers or average pooling layers. For example, max pooling layers may use the maximum value from each of a cluster of neurons in the prior layer; and average pooling layers may use the average value from each of a cluster of neurons at the prior layer.

In some embodiments, the fully-connected layers connect every neuron in one layer to every neuron in another layer. In neural networks, each neuron may receive input from some number locations in the previous layer. In a fully-connected layer, each neuron may receive input from every element of the previous layer.

In some embodiments, the normalization layer is a batch normalization layer. The batch normalization layer may improve the performance and stability of neural networks. The batch normalization layer may provide any layer in a neural network with inputs that are zero mean/unit variance. The advantages of using batch normalization layer may include faster trained networks, higher learning rates, easier to initialize weights, more activation functions viable, and simpler process of creating deep networks.

In some embodiments, the neural network comprises one or more residual connections. Residual connections may allow information to flow through a network without passing through a nonlinear activation function. Residual connections may facilitate training of the neural network by allowing training to converge faster.

In some embodiments, the neural network comprises a dropout layer. Dropout layers can disable or zero out inputs with a trained or preconfigured probability. Dropout layers may help avoid overfitting without incurring the computational cost of training multiple (e.g., an ensemble of) neural networks.

In some embodiments, a trained algorithm comprises a recurrent neural network (RNN). RNNs are neural networks with cyclical connections that can encode and process sequential data, such as a sequence of a peptide or protein. An RNN can include an input layer that is configured to receive a sequence of inputs. An RNN may additionally include one or more hidden recurrent layers that maintain a state. At each step, each hidden recurrent layer can compute an output and a next state for the layer. The next state may depend on the previous state and the current input. The state may be maintained across steps and may capture dependencies in the input sequence.

An RNN can be a long short-term memory (LSTM) network. An LSTM network may be made of LSTM units. An LSTM unit may include of a cell, an input gate, an output gate, and a forget gate. The cell may be responsible for keeping track of the dependencies between the elements in the input sequence. The input gate can control the extent to which a new value flows into the cell, the forget gate can control the extent to which a value remains in the cell, and the output gate can control the extent to which the value in the cell is used to compute the output activation of the LSTM unit.

Alternatively, a machine learning algorithm can comprise a transformer. A transformer may be a model without recurrent connections. Instead, it may rely on an attention mechanism. Attention mechanisms may focus on, or “attend to,” certain input regions while ignoring others. This may increase model performance because certain input regions may be less relevant. At each step, an attention unit can compute a dot product of a context vector and the input at the step, among other operations. The output of the attention unit may define where the most relevant information in the input sequence is located.

In some embodiments, the neural network may comprise a pretrained neural network. Training a neural network can require substantial time and resources. Leveraging a pretrained neural network (e.g., such as an image classification model which has already been trained to extract relevant features from natural images) can be much faster and easier than training a neural network from scratch. In some embodiments, neural networks as described herein are trained by transfer learning from a pretrained neural network. In some embodiments, the pretrained neural network comprises any one of VGG-19, ResNet, Inception, MobileNet, and EfficientNet.

The trained algorithm may comprise a classifier, such that each of the one or more output values comprises one of a fixed number of possible values (e.g., a linear classifier, a logistic regression classifier, perceptron, etc.) indicating a classification of the input data, and/or a sample or subject from which the input data is derived, by the classifier. The trained algorithm may comprise a binary classifier, such that each of the one or more output values comprises one of two values (e.g., {0, 1}, {positive, negative}, or {high-risk, low-risk}) indicating a classification of the data and/or subject by the classifier. The trained algorithm may be another type of classifier, such that each of the one or more output values comprises one of more than two values (e.g., {0, 1, 2}, {positive, negative, or indeterminate}, or {high-risk, intermediate-risk, or low-risk}) indicating a classification of the data and/or subject. The trained algorithm may comprise a plurality of binary classifiers. The output values may comprise descriptive labels, numerical values, or a combination thereof. Some of the output values may comprise descriptive labels. Some of the output values may comprise numerical values, such as binary, integer, or continuous values. Such binary output values may comprise, for example, {0, 1}, {positive, negative}, or {high-risk, low-risk}. Such integer output values may comprise, for example, {0, 1, 2}. Such continuous output values may comprise, for example, a probability value of at least 0 and no more than 1. Such continuous output values may comprise, for example, an un-normalized probability value of at least 0. Some numerical values may be mapped to descriptive labels, for example, by mapping 1 to “positive” and 0 to “negative.” In some embodiments, a classifier may comprise a binary classifier. In some embodiments, the classifier may comprise a multiclass classifier. The multiclass classifier may be configured to classify input data into one of at least 3, 4, 5, 6, 7, 8, 9, 10, 11, 12, 13, 14, 15, 16, 17, 18, 19, 20, 30, 40, or 50, or more classes. The multiclass classifier may be configured to classify input data into one of no more than 50, 40, 30, 20, 19, 18, 17, 16, 15, 14, 13, 12, 11, 10, 9, 8, 7, 6, 5, 4, or 3 classes.

The trained algorithm may be trained with a plurality of independent training samples. Each of the independent training samples may comprise a mass spectrum or plurality thereof and an experimental parameter. The trained algorithm may be trained with at least about 5, at least about 10, at least about 15, at least about 20, at least about 25, at least about 30, at least about 35, at least about 40, at least about 45, at least about 50, at least about 100, at least about 150, at least about 200, at least about 250, at least about 300, at least about 350, at least about 400, at least about 450, at least about 500, at least about 1,000, at least about 1,500, at least about 2,000, at least about 2,500, at least about 3,000, at least about 3,500, at least about 4,000, at least about 4,500, at least about 5,000, at least about, 5,500, at least about 6,000, at least about 6,500, at least about 7,000, at least about 7,500, at least about 8,000, at least about 8,500, at least about 9,000, at least about 9,500, at least about 10,000, or more independent training samples. The trained algorithm may be trained with at most about 5, at most about 10, at most about 15, at most about 20, at most about 25, at most about 30, at most about 35, at most about 40, at most about 45, at most about 50, at most about 100, at most about 150, at most about 200, at most about 250, at most about 300, at most about 350, at most about 400, at most about 450, at most about 500, at most about 1,000, at most about 1,500, at most about 2,000, at most about 2,500, at most about 3,000, at most about 3,500, at most about 4,000, at most about 4,500, at most about 5,000, at most about, 5,500, at most about 6,000, at most about 6,500, at most about 7,000, at most about 7,500, at most about 8,000, at most about 8,500, at most about 9,000, at most about 9,500, or at most about 10,000 training samples.

Various loss functions can be used to train the neural network. In some embodiments, the neural network may comprise a regression loss function. In some embodiments, the neural network may comprise a logistic loss function. In some embodiments, the neural network may comprise a variational loss. In some embodiments, the neural network may comprise a binary cross-entropy loss. In some embodiments, the neural network may comprise a categorical cross-entropy loss. In some embodiments, the neural network may comprise an adversarial loss. In some embodiments, the neural network may comprise a reconstruction loss.

Various optimizers can be used to train the neural network. In some embodiments, the neural network may be trained with the Adam optimizer. In some embodiments, the neural network may be trained with the stochastic gradient descent optimizer. In some embodiments, the neural network may be trained with an active learning algorithm. A neural network may be trained with various loss functions whose derivatives may be computed to update one or more parameters of the neural network. A neural network may be trained with hyperparameter searching algorithms.

Various training protocols can be used while training the neural network. In some embodiments, the neural network may be trained with train/validation/test data splits. In some embodiments, the neural network may be trained with k-fold data splits, with any positive integer for k.

Training the neural network can involve providing inputs to the untrained neural network to generate predicted outputs, comparing the predicted outputs to the expected outputs, and updating the neural network's parameters to account for the difference between the predicted outputs and the expected outputs. Based on the calculated difference, a gradient with respect to each parameter may be calculated by backpropagation to update the parameters of the neural network so that the output value(s) that the neural network computes are consistent with the examples included in the training set. This process may be iterated for a certain number of iterations or until some stopping criterion is met.

The trained algorithm may associate a mass spectrum (e.g., image map) with a predicted experimental parameter at an accuracy of at least about 50%, at least about 55%, at least about 60%, at least about 65%, at least about 70%, at least about 75%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or more. The accuracy of associating the mass spectrum or and the experimental parameter by the trained algorithm may be calculated as the percentage of independent test samples (e.g., mass spectra of known to be associated the experimental parameter) that are correctly predicted.

The trained algorithm may associate a mass spectrum (e.g., an image map) with an experimental parameter with a positive predictive value (PPV) or precision of at least about 5%, at least about 10%, at least about 15%, at least about 20%, at least about 25%, at least about 30%, at least about 35%, at least about 40%, at least about 50%, at least about 55%, at least about 60%, at least about 65%, at least about 70%, at least about 75%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or more. The PPV or precision of associating the mass spectrum and the experimental parameter using the trained algorithm may be calculated as the percentage of mass spectra classified or predicted to be associated with the experimental parameter that are truly associated with the experimental parameter.

The trained algorithm may associate a mass spectrum (e.g., an image map) with an experimental parameter with a negative predictive value (NPV) of at least about 5%, at least about 10%, at least about 15%, at least about 20%, at least about 25%, at least about 30%, at least about 35%, at least about 40%, at least about 50%, at least about 55%, at least about 60%, at least about 65%, at least about 70%, at least about 75%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or more. The NPV of associating the mass spectrum with the experimental parameter using the trained algorithm may be calculated as the percentage of mass spectra not classified or predicted to not be associated with the experimental parameter that truly are not associated with the experimental parameter.

The trained algorithm may associate a mass spectrum (e.g., an image map) with an experimental parameter with a sensitivity or recall of at least about 5%, at least about 10%, at least about 15%, at least about 20%, at least about 25%, at least about 30%, at least about 35%, at least about 40%, at least about 50%, at least about 55%, at least about 60%, at least about 65%, at least about 70%, at least about 75%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, at least about 99.8%, at least about 99.9%, at least about 99.99%, at least about 99.999%, or more. The sensitivity or recall of associating the mass spectrum with the experimental parameter using the trained algorithm may be calculated as the percentage of independent test samples associated with the mass spectrum (e.g., mass spectra known to comprise or be associated with the experimental parameter) that are correctly identified or classified as associated with the experimental parameter.

The trained algorithm may associate a mass spectrum (e.g., an image map) with an experimental parameter with a specificity of at least about 5%, at least about 10%, at least about 15%, at least about 20%, at least about 25%, at least about 30%, at least about 35%, at least about 40%, at least about 50%, at least about 55%, at least about 60%, at least about 65%, at least about 70%, at least about 75%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, at least about 99.8%, at least about 99.9%, at least about 99.99%, at least about 99.999%, or more. The specificity of associating the mass spectrum with the experimental parameter using the trained algorithm may be calculated as the percentage of independent test samples associated with an absence of the experimental parameter (e.g., mass spectra known not to comprise or be associated with the experimental parameter) that are correctly identified or classified as not associated with the experimental parameter.

The trained algorithm may associate a mass spectrum (e.g., an image map) with an experimental parameter with an F1-score of at least about 0.5, at least about 0.10, at least about 0.15, at least about 0.20, at least about 0.25, at least about 0.30, at least about 0.35, at least about 0.40, at least about 0.50, at least about 0.55, at least about 0.60, at least about 0.65, at least about 0.70, at least about 0.75, at least about 0.80, at least about 0.81, at least about 0.82, at least about 0.83, at least about 0.84, at least about 0.85, at least about 0.86, at least about 0.87, at least about 0.88, at least about 0.89, at least about 0.90, at least about 0.91, at least about 0.92, at least about 0.93, at least about 0.94, at least about 0.95, at least about 0.96, at least about 0.97, at least about 0.98, at least about 0.99, at least about 0.991, at least about 0.992, at least about 0.993, at least about 0.994, at least about 0.995, at least about 0.996, at least about 0.997, at least about 0.998, at least about 0.999, at least about 0.9999, at least about 0.99999, or more. The F1-score of associating the mass spectrum with the experimental parameter using the trained algorithm may be calculated as the harmonic mean of the sensitivity and specificity associated with the trained algorithm of associating mass spectra with the experimental parameter.

The trained algorithm may associate a mass spectrum (e.g., an image map) with an experimental parameter with an Area-Under-Curve (AUC) of at least about 0.50, at least about 0.55, at least about 0.60, at least about 0.65, at least about 0.70, at least about 0.75, at least about 0.80, at least about 0.81, at least about 0.82, at least about 0.83, at least about 0.84, at least about 0.85, at least about 0.86, at least about 0.87, at least about 0.88, at least about 0.89, at least about 0.90, at least about 0.91, at least about 0.92, at least about 0.93, at least about 0.94, at least about 0.95, at least about 0.96, at least about 0.97, at least about 0.98, at least about 0.99, or more. The AUC may be calculated as an integral of the Receiver Operator Characteristic (ROC) curve (e.g., the area under the ROC curve) associated with the trained algorithm in classifying datasets derived from a mass spectrum as being associated or not associated with the experimental parameter.

The trained algorithm may be adjusted or tuned to improve one or more of the performance, accuracy, PPV (or precision), NPV, sensitivity (or recall), specificity, F1-score, AUC, or any combination thereof of predicting the property of the mass spectrum. The trained algorithm may be adjusted or tuned by adjusting parameters of the trained algorithm (e.g., weights of a neural network). The trained algorithm may be adjusted or tuned continuously during the training process or after the training process has completed.

After the trained algorithm is initially trained, a subset of the inputs may be identified as most influential or most important to be included for making high-quality predictions. For example, a subset of the data may be identified as most influential or most important to be included for making high-quality predictions of associations of mass spectra with experimental parameters. The data or a subset thereof may be ranked based on classification metrics indicative of each parameter's influence or importance toward making high-quality associations of predicted properties with sequence. Such metrics may be used to reduce, in some cases significantly, the number of input variables (e.g., predictor variables) that may be used to train the trained algorithm to a desired performance level (e.g., based on a desired minimum accuracy, PPV (or precision), NPV, sensitivity (or recall), specificity, F1-score, AUC, or a combination thereof). For example, if training the trained algorithm with a plurality comprising several dozen or hundreds of input variables in the trained algorithm results in an accuracy of classification of more than 99%, then training the trained algorithm instead with only a selected subset of no more than about 5, no more than about 10, no more than about 15, no more than about 20, no more than about 25, no more than about 30, no more than about 35, no more than about 40, no more than about 45, no more than about 50, or no more than about 100 such most influential or most important input variables among the plurality can yield decreased but still acceptable accuracy of classification (e.g., at least about 50%, at least about 55%, at least about 60%, at least about 65%, at least about 70%, at least about 75%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99%). The subset may be selected by rank-ordering the entire plurality of input variables and selecting a predetermined number (e.g., no more than about 5, no more than about 10, no more than about 15, no more than about 20, no more than about 25, no more than about 30, no more than about 35, no more than about 40, no more than about 45, no more than about 50, or no more than about 100) of input variables with the best association metrics.

Systems and methods as described herein may use more than one trained algorithm to determine an output (e.g., prediction of a mass spectrum as being associated with an experimental parameter). Systems and methods may comprise 1, 2, 3, 4, 5, 6, 7, 8, 9, 10, 11, 12, 13, 14, 15, 16, 17, 18, 19, 20, or more trained algorithms. A trained algorithm of the plurality of trained algorithms may be trained on a particular type of data (e.g., image data). Alternatively, a trained algorithm may be trained on more than one type of data. The inputs of one trained algorithm may comprise the outputs of one or more other trained algorithms. Additionally, a trained algorithm may receive as its input the output of one or more trained algorithms.

### Computer Systems

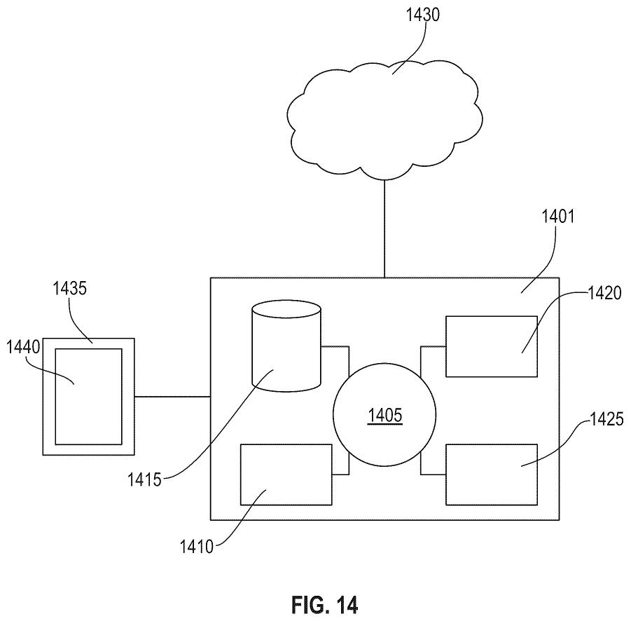

The present disclosure provides computer systems that are programmed to implement methods and algorithms of the disclosure. FIG. 14 shows a computer system 1401 that is programmed or otherwise configured to, for example, analyze, convert, and/or display omics data.

The computer system 1401 may regulate various aspects of analysis, calculation, and generation of the present disclosure, such as, for example, converting, analyzing, and/or displaying omics data. The computer system 1401 may be an electronic device of a user or a computer system that is remotely located with respect to the electronic device. The electronic device may be a mobile electronic device.

The computer system 1401 includes a central processing unit (CPU, also “processor” and “computer processor” herein) 1405, which may be a single core or multi core processor, or a plurality of processors for parallel processing. The computer system 1401 also includes memory or memory location 1410 (e.g., random-access memory, read-only memory, flash memory), electronic storage unit 1415 (e.g., hard disk), communication interface 1420 (e.g., network adapter) for communicating with one or more other systems, and peripheral devices 1425, such as cache, other memory, data storage and/or electronic display adapters. The memory 1410, storage unit 1415, interface 1420 and peripheral devices 1425 are in communication with the CPU 1405 through a communication bus (solid lines), such as a motherboard. The storage unit 1415 may be a data storage unit (or data repository) for storing data. The computer system 1401 may be operatively coupled to a computer network (“network”) 1430 with the aid of the communication interface 1420. The network 1430 may be the Internet, an internet and/or extranet, or an intranet and/or extranet that is in communication with the Internet.

The network 1430 in some cases is a telecommunication and/or data network. The network 1430 may include one or more computer servers, which may enable distributed computing, such as cloud computing. For example, one or more computer servers may enable cloud computing over the network 1430 (“the cloud”) to perform various aspects of analysis, calculation, and generation of the present disclosure, such as, for example, converting, analyzing, and/or displaying omics data. Such cloud computing may be provided by cloud computing platforms such as, for example, Amazon Web Services (AWS), Microsoft Azure, Google Cloud Platform, and IBM cloud. The network 1430, in some cases with the aid of the computer system 1401, may implement a peer-to-peer network, which may enable devices coupled to the computer system 1401 to behave as a client or a server.

The CPU 1405 may comprise one or more computer processors and/or one or more graphics processing units (GPUs). The CPU 1405 may execute a sequence of machine-readable instructions, which may be embodied in a program or software. The instructions may be stored in a memory location, such as the memory 1410. The instructions may be directed to the CPU 1405, which may subsequently program or otherwise configure the CPU 1405 to implement methods of the present disclosure. Examples of operations performed by the CPU 1405 may include fetch, decode, execute, and writeback.

The CPU 1405 may be part of a circuit, such as an integrated circuit. One or more other components of the system 1401 may be included in the circuit. In some embodiments, the circuit is an application specific integrated circuit (ASIC).

The storage unit 1415 may store files, such as drivers, libraries and saved programs. The storage unit 1415 may store user data, e.g., user preferences and user programs. The computer system 1401 in some cases may include one or more additional data storage units that are external to the computer system 1401, such as located on a remote server that is in communication with the computer system 1401 through an intranet or the Internet.

The computer system 1401 may communicate with one or more remote computer systems through the network 1430. For instance, the computer system 1401 may communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user may access the computer system 1401 via the network 1430.

Methods as described herein may be implemented by way of machine (e.g., computer processor) executable code stored on an electronic storage location of the computer system 1401, such as, for example, on the memory 1410 or electronic storage unit 1415. The machine executable or machine readable code may be provided in the form of software. During use, the code may be executed by the processor 1405. In some embodiments, the code may be retrieved from the storage unit 1415 and stored on the memory 1410 for ready access by the processor 1405. In some situations, the electronic storage unit 1415 may be precluded, and machine-executable instructions are stored on memory 1410.

The code may be pre-compiled and configured for use with a machine having a processer adapted to execute the code, or may be compiled during runtime. The code may be supplied in a programming language that may be selected to enable the code to execute in a pre-compiled or as-compiled fashion.

Aspects of the systems and methods provided herein, such as the computer system 1401, may be embodied in programming. Various aspects of the technology may be thought of as “products” or “articles of manufacture” typically in the form of machine (or processor) executable code and/or associated data that is carried on or embodied in a type of machine readable medium. Machine-executable code may be stored on an electronic storage unit, such as memory (e.g., read-only memory, random-access memory, flash memory) or a hard disk. “Storage” type media may include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1401 may include or be in communication with an electronic display 1435 that comprises a user interface (UI) 1440 for providing, for example, converting, analyzing, and/or displaying omics data. Examples of UIs include, without limitation, a graphical user interface (GUI) and web-based user interface.

Methods and systems of the present disclosure may be implemented by way of one or more algorithms. An algorithm may be implemented by way of software upon execution by the central processing unit 1405. The algorithm can, for example, converting, analyzing, and/or displaying omics data.

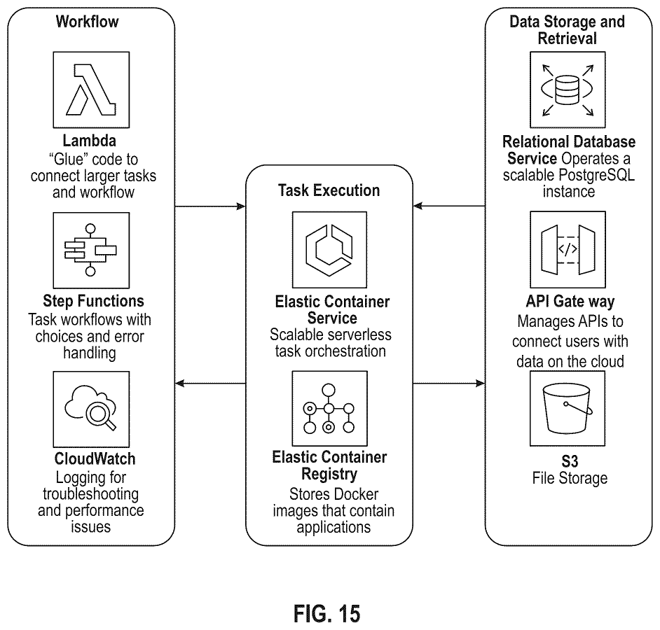

FIG. 15 schematically illustrates a cloud-based distributed computing environment, in accordance with some embodiments. In some embodiments, a computer system or a computer-implemented method of the present disclosure are configured to perform instructions on an event-driven and serverless platform. In some embodiments, instructions are performed with concurrency. In some embodiments, instructions are performed with scaling controls. In some embodiments, instructions can be packaged in container images. The container images can be configured to run on a variety of computing environments. In some embodiments, instructions comprise a signature for verifying integrity of the instructions. In some embodiments, instructions comprise a database proxy. The database proxy can manage a plurality of database connections and relay a query from an instruction to a database. In some embodiments, instructions can store or retrieve datasets from an elastic storage system, a local storage system, or both. In some embodiments, instructions comprise one or more states that indicate which instruction was last performed and/or which instruction is to be performed next. In some embodiments, instructions automatically logs events (e.g., errors or performance issues) that occur while the instructions are performed.

Containers for instructions can be deployed on serverless computing instance. A first subset of the instructions can be retrieved and used on a first instance. A second subset of the instructions can be retrieved and used on a second instance. The first subset of the instructions and the second subset of the instructions can be orchestrated to be performed together using the first instance and the second instance in parallel. The size of the first instance and the second instance can be based on the complexity of the first subset of instructions, the second subset of instructions, the amount of the dataset to be processed, or any combination thereof.

Datasets can be stored and retrieved from a variety of storage systems. In some embodiments, a storage system can be a relational database. In some embodiments, a storage system can be a non-relational database. In some embodiments, a storage system can be a distributed database. In some embodiments, a storage system can be an object-based database.

### EXAMPLES

The following illustrative examples are representative of embodiments of the software applications, systems, and methods described herein and are not meant to be limiting in any way.

### Example 1—Identifying Experimental Parameters of Mass Spectrometry Runs from MS1 Scans

This example demonstrates a representative workflow for identifying experimental parameters of mass spectrometry runs by analyzing corresponding MS1 scans.

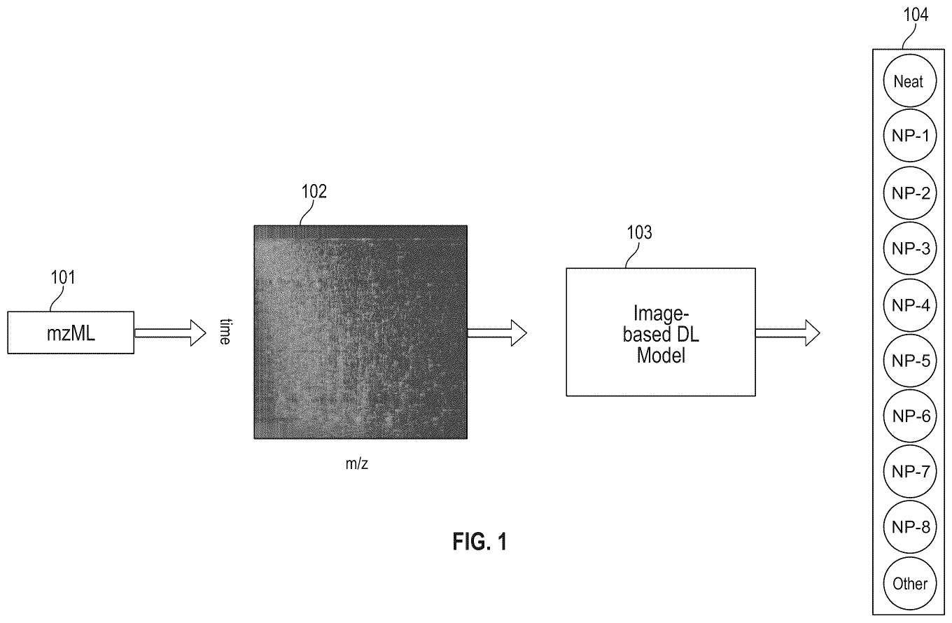

A deep learning (DL) model as described herein was developed for predicting surface types used in a surface-interaction based proteomics assay. FIG. 1 provides a schematic showing the basic workflow of the QC method utilizing a NN model to process MS1 scan data as an image, where the MS1 data is compressed mzML raw data 101. The raw data 101 was converted to image maps 102 which were passed to image-based DL model 103 to output classifications 104 of an experimental parameter. The DL architecture comprised a 10-way classifier for classifying a predicted surface type that had been used to isolate and/or enrich biomolecules for mass spectrometry. The architecture was based on EfficientNetB0 where the final layers were replaced with a GlobalAveragePooling layer and a dense layer with 10 nodes with a softmax activation for the classification. A training data set as described in Table 1 was curated for training and testing the model. The test samples were split up as 80% train (9890 runs), 10% test1 and 10% test2. The training set was further split, with 20% held for validation for each epoch (7912 train, 1978 validation).

TABLE 1
Training data characteristics

| Surface | Runs |
|---|---|
| NONE | 374 |
| NP-1 | 1785 |
| NP-2 | 2006 |
| NP-3 | 1613 |
| NP-4 | 867 |
| NP-5 | 838 |
| NP-6 | 734 |
| NP-7 | 866 |
| NP-8 | 948 |
| Other | 958 |

MS1 scans were extracted from mzML data and binned into 1300×1300-pixel images (m/z range 300 to 1600 at 1 m/z resolution and retention time range 4 to 30 min, sampling about 50 MS1 spectra per bin). Missing and 0 values were set to the minimum value, and the data were log 10 transformed and normalized.

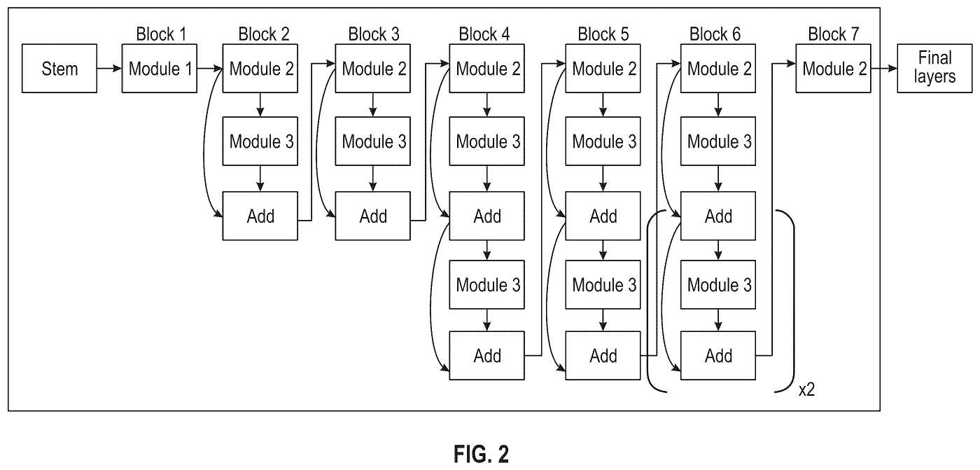

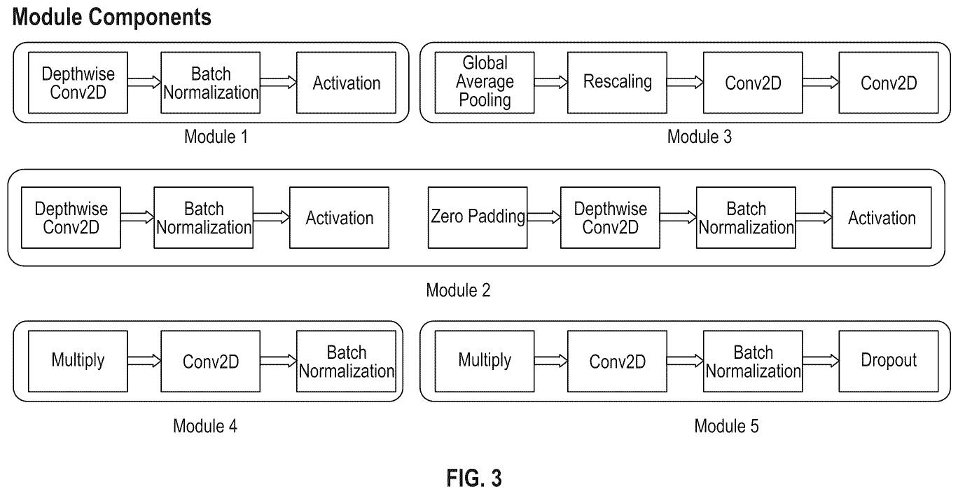

FIGS. 2 and 3 show schematic representations of the neural network architecture. The neural network comprised 237 split across seven blocks preceded by a stem layer which downsampled the input and followed by the final dense layer for classification. The modules illustrated in FIG. 2 comprised combinations of individual convolution, batch normalization, activation, rescaling, global average pooling, zero padding, and dropout layers, as illustrated in FIG. 3.

Training was carried out by minimizing categorical cross entropy with an Adam optimizer. Training was conducted for 40 epochs and classification accuracy of the validation set was found to be 0.8235. Table 2 shows validation performance across each of the 10 classes comprising the possible predicted surface types (Neat, NP-1, NP-2, NP-3, NP-4, NP-5, NP-6, NP-7, NP-8, and Other). Table 3 shows the performance of the model on classifying test set “Test1” as described above.

TABLE 2
Validation performance

| | Precision | Recall | F1 score | Support |
|---|---|---|---|---|
| NONE | 0.94 | 0.94 | 0.94 | 36 |
| OtherNP | 0.66 | 0.67 | 0.67 | 94 |
| NP-1 | 0.92 | 0.87 | 0.89 | 167 |
| NP-2 | 0.87 | 0.9 | 0.88 | 207 |
| NP-3 | 0.84 | 0.97 | 0.9 | 136 |
| NP-4 | 0.79 | 0.73 | 0.76 | 81 |
| NP-5 | 0.82 | 0.89 | 0.85 | 75 |
| NP-6 | 0.9 | 0.63 | 0.74 | 70 |
| NP-7 | 0.88 | 0.86 | 0.87 | 79 |
| NP-8 | 0.86 | 0.89 | 0.87 | 79 |
| accuracy | | | 0.85 | 1024 |
| macro avg | 0.85 | 0.83 | 0.84 | 1024 |
| weighted avg | 0.85 | 0.85 | 0.85 | 1024 |

TABLE 3
Test Performance

| | Precision | Recall | F1 score | Support |
|---|---|---|---|---|
| NONE | 0.9 | 0.93 | 0.91 | 40 |
| OtherNP | 0.53 | 0.58 | 0.55 | 90 |
| NP-1 | 0.91 | 0.84 | 0.87 | 177 |
| NP-2 | 0.83 | 0.87 | 0.85 | 197 |
| NP-3 | 0.82 | 0.97 | 0.89 | 179 |
| NP-4 | 0.76 | 0.69 | 0.73 | 88 |
| NP-5 | 0.86 | 0.87 | 0.87 | 85 |
| NP-6 | 0.88 | 0.56 | 0.69 | 64 |
| NP-7 | 0.87 | 0.79 | 0.83 | 82 |
| NP-8 | 0.88 | 0.89 | 0.88 | 97 |
| accuracy | | | 0.82 | 1099 |
| macro avg | 0.82 | 0.8 | 0.81 | 1099 |
| weighted avg | 0.83 | 0.82 | 0.82 | 1099 |

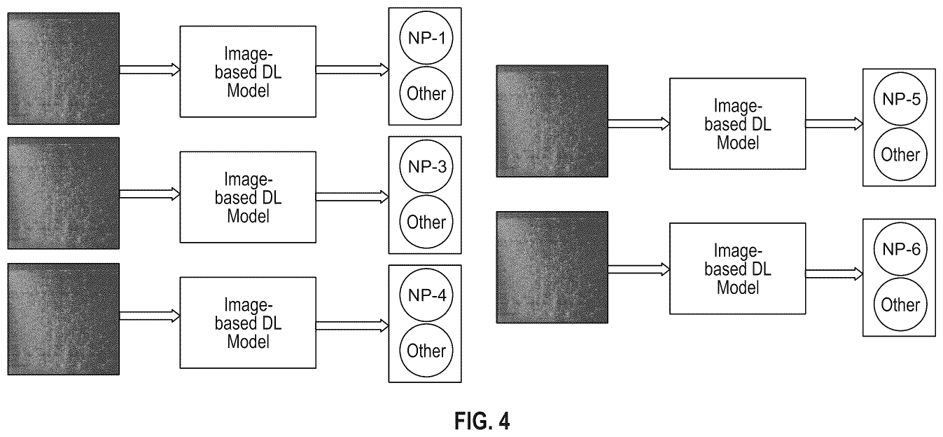

A model comprising a set of five binary classifiers was also constructed, trained, and assessed analogously to the 10-way classification model described above. FIG. 4 depicts a set of binary classifiers configured to classify as opposed to the 10-way classifier (e.g., fitted model) depicted in FIG. 1.

TABLE 4
Binary Classifier Validation Performance

| | | | |
|---|---|---|---|
| Precision | Recall | F1 score | Support |

Classifier 1

| | | | | |
|---|---|---|---|---|
| not | 0.97 | 0.93 | 0.95 | 857 |
| NP-1 | 0.71 | 0.83 | 0.77 | 167 |

Classifier 2

| | | | | |
|---|---|---|---|---|
| not | 0.99 | 0.9 | 0.94 | 888 |
| NP-3 | 0.59 | 0.92 | 0.72 | 136 |

Classifier 3

| | | | | |
|---|---|---|---|---|
| not | 0.98 | 0.88 | 0.93 | 943 |
| NP-4 | 0.36 | 0.78 | 0.49 | 81 |

Classifier 4

| | | | | |
|---|---|---|---|---|
| not | 0.99 | 0.9 | 0.94 | 949 |
| NP-5 | 0.42 | 0.88 | 0.57 | 75 |

Classifier 5

| | | | | |
|---|---|---|---|---|
| not | 0.98 | 0.91 | 0.94 | 954 |
| NP-6 | 0.36 | 0.69 | 0.47 | 70 |

TABLE 5
Binary Classification Test Performance

| | | | |
|---|---|---|---|
| Precision | Recall | F1 score | Support |

Classifier 1

| | | | | |
|---|---|---|---|---|
| not | 0.96 | 0.95 | 0.96 | 922 |
| NP-1 | 0.76 | 0.79 | 0.77 | 177 |

Classifier 2

| | | | | |
|---|---|---|---|---|
| not | 0.98 | 0.9 | 0.94 | 920 |
| NP-3 | 0.63 | 0.92 | 0.75 | 179 |

Classifier 3

| | | | | |
|---|---|---|---|---|
| not | 0.98 | 0.88 | 0.93 | 1011 |
| NP-4 | 0.36 | 0.81 | 0.5 | 88 |

Classifier 4

| | | | | |
|---|---|---|---|---|
| not | 0.99 | 0.92 | 0.95 | 1014 |
| NP-5 | 0.46 | 0.86 | 0.6 | 85 |

Classifier 5

| | | | | |
|---|---|---|---|---|
| not | 0.98 | 0.91 | 0.95 | 1035 |
| NP-6 | 0.34 | 0.75 | 0.47 | 64 |

### Example 2—LC-MS MS1 Data Classification Enabling Real-Time Sample Quality Control for Nanoparticle-Based Deep Untargeted Proteomics

This example demonstrates a representative QC procedure for a proteomics profiling workflow that utilizes machine learning on the MS1 image maps of raw LC-MS data to help identify unexpected patterns and highlight potential issues for further investigation. The machine learning model can enable real-time monitoring of data quality, facilitate troubleshooting analysis for root cause investigations, and ensure that only high-quality LC-MS data are used for in the analysis.

### Method and Model Architecture

Input data was curated from thousands of LC-MS runs to provide a set of high-quality, representative examples for model training. Image maps were created using the MS1 scans extracted from raw mzML files, binned into high-resolution images projecting the spectrum intensities into color maps along the m/z and retention time axes. A deep learning (DL) image analysis model was then trained to detect deviations from the expected MS1 scan (or training MS1 scan).

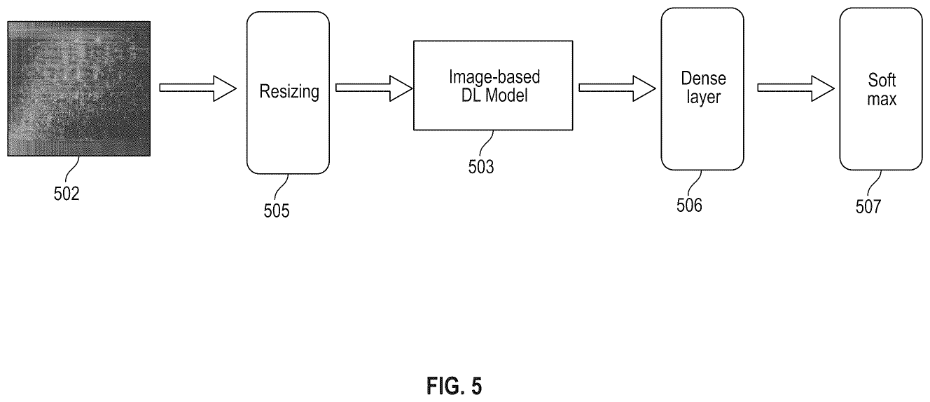

The workflow schematic used in this example is illustrated in FIG. 5. Image map 502 was first passed through a resizing layer 505 to resize the image map 502 from a 1300×1300 pixel image map to a 256×256 pixel image map. The resized image map was then based through image-based DL model 503 which was configured to detect deviations from an expected MS1 scan. Finally, classification of the input was performed by a dense layer 506 connected to softmax activation layer 507. The image-based DL model comprised the architecture illustrated in FIGS. 2 and 3.

### Training

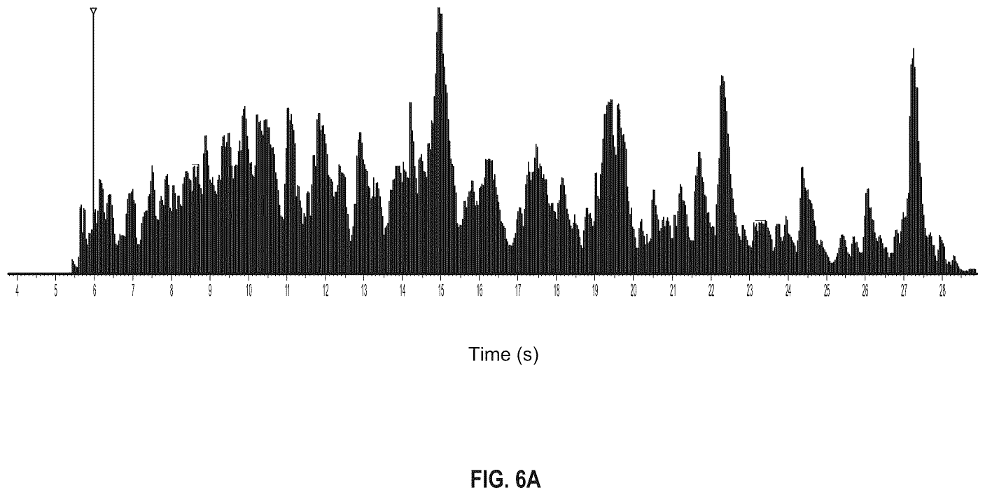

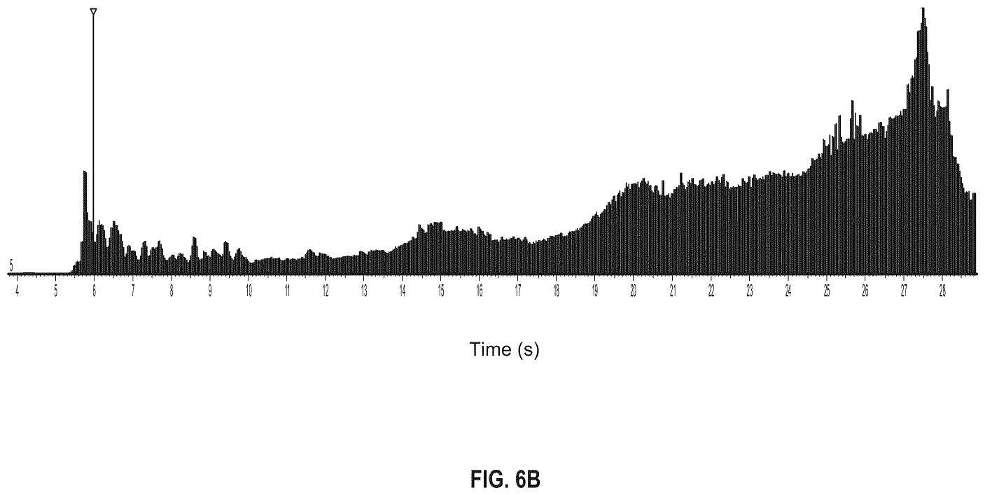

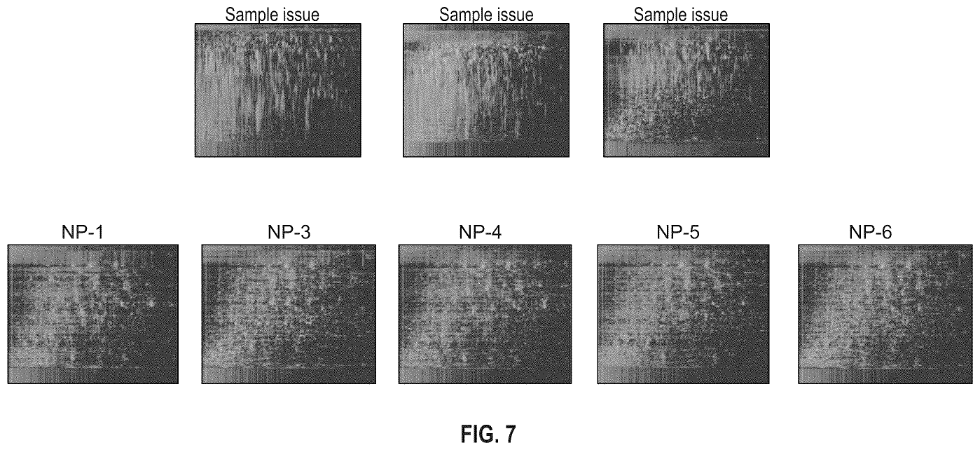

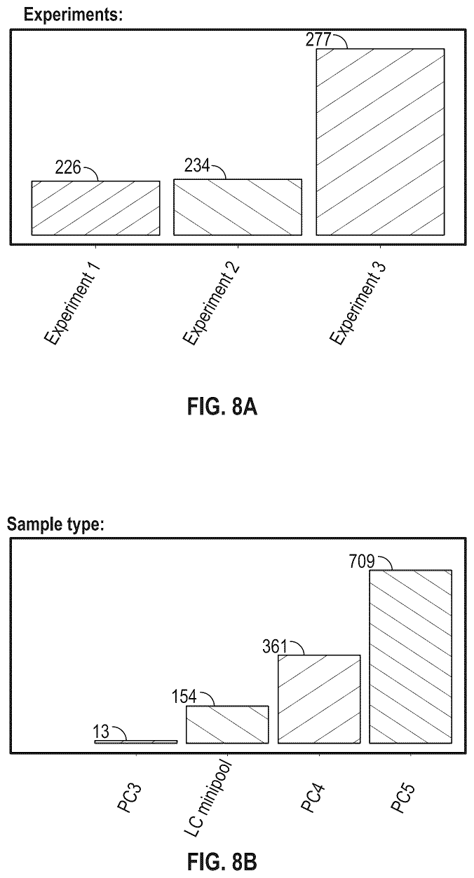

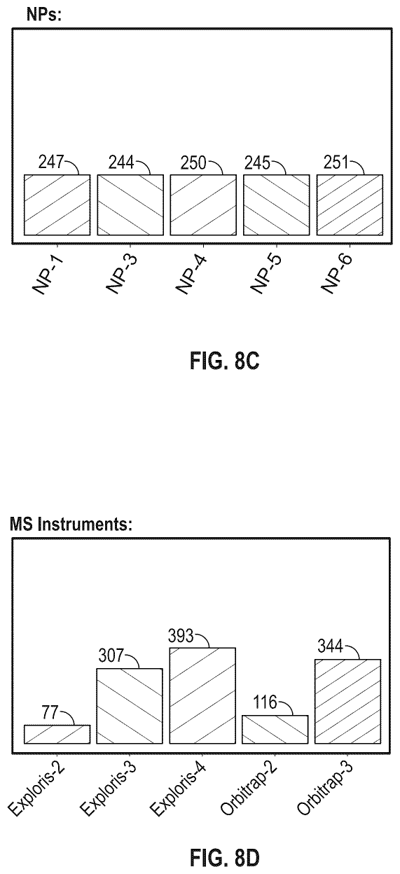

The model was trained for 40 epochs, minimizing categorical cross entropy loss with an Adam optimizer. The final model was then employed to classify the expected nanoparticle from the MS1 image of a given run. The model was trained on 1,313 unique MS runs from multiple PROTEOGRAPH™ workflows comprising diverse biological plasma sample types. Specifically, the model was trained on 1237 “good” runs showing expected total ion current (TIC) chromatograms with expected topology across five different nanoparticle types (NP-1, NP-3, NP-4, NP-5, and NP-6) and 76 “bad” runs showing TIC chromatograms with abnormal topology (“Sample_Issue”). A representative “good” TIC chromatogram is illustrated in FIG. 6A, and a “bad” TIC chromatogram is illustrated in FIG. 6B. The good runs comprised MS1 scans from the PROTEOGRAPH™ nanoparticle panel taken from three separate experiments. The bad runs comprised TIC failures caused by surfactant contamination. Representative MS1 scans for the five nanoparticle types each labeled as NP-1, NP-3, NP-4, NP-5, and NP-6, respectively, can be seen in the bottom row of FIG. 7. Three different MS1 scans from runs characterized with sample issues can also be seen in the top row of FIG. 7. The training results using standardized good runs as the training data are illustrated in FIGS. 8A-8D. FIG. 8A shows a graph depicting the number of runs (MS1 scans) in each group. FIG. 8B depicts the number of runs (MS1 scans) per sample type. FIG. 8C depicts the number of runs per nanoparticle type. FIG. 8D depicts the number of runs per MS instrument type. In each plot, all 1237 good runs are represented in each category.

Test samples were split into train (60%), validation (20%) and hold-out test (20%) groups. Validation samples were used for validation each epoch to track model convergence while test samples were used to test the final trained model. Model training was carried out for 40 epochs with a batch size of 32, minimizing categorical cross entropy loss with an Adam optimizer. The model was configured to output a 6-way classification (each of the five nanoparticle types and a bad “Sample_Issue” classification). Classification accuracy of the validation set was found to be 0.972. Results for the hold-out test set across each classification are shown in Table 6 below.

TABLE 6
Hold-out test results

| | Precision | Recall | F1 score | Support |
|---|---|---|---|---|
| NP-1 | 1.00 | 0.92 | 0.96 | 50 |
| NP-3 | 1.00 | 1.00 | 1.00 | 50 |
| NP-4 | 0.98 | 0.98 | 0.98 | 50 |
| NP-5 | 0.91 | 1.00 | 0.95 | 49 |
| NP-6 | 1.00 | 0.98 | 0.99 | 51 |
| Sample_Issue | 0.94 | 0.94 | 0.94 | 16 |
| Accuracy | | | 0.97 | 266 |
| Macro average | 0.97 | 0.97 | 0.97 | 266 |
| Weighted | 0.98 | 0.97 | 0.97 | 266 |
| average | | | | |

Shown above are the trained model's precision, Recall and F1 score for each class and its support value across each sample type in the test set. The model was able to distinguish not only each sample type from another, but also properly distinguish bad sample (“sample_issue” class).

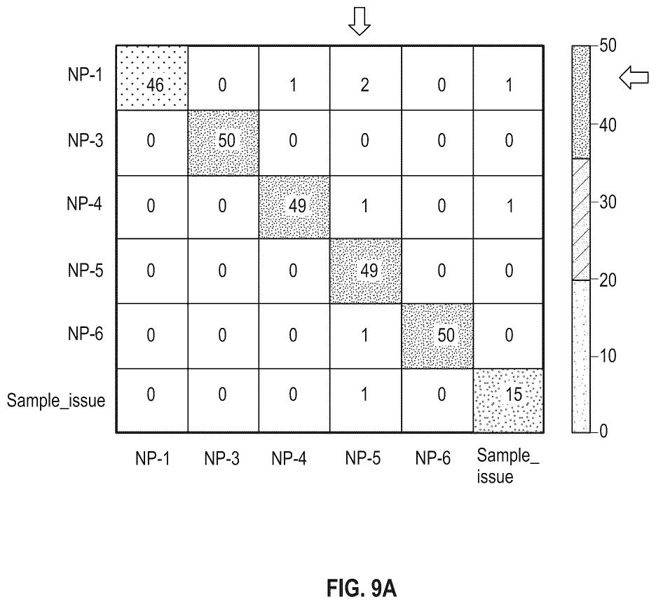

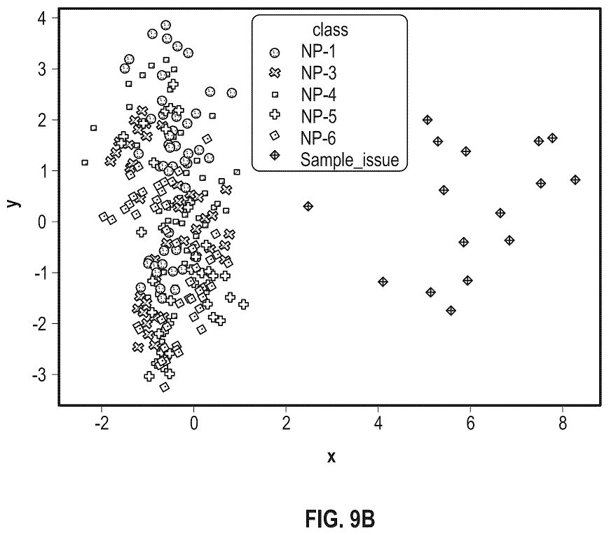

FIG. 9A further depicts the hold-out test results in the form of an error analysis matrix. The matrix displays the true label on the x axis and the predicted label on the y-axis. The values of each matrix element indicate the number of test samples that meet the condition of each row column position. For example, test samples with a true label of ‘NP-1’ and also predicted to have that label are binned into row 1 column 1. FIG. 9B depicts a Principal Component Analysis (PCA) plot of the output for the penultimate layer of the image analysis model for all 266 test samples, coded by sample type (e.g., nanoparticle class or sample issue). All 16 members of the “bad” sample_issue class are segregated from the other classes along the first principal component (x-axis), suggesting that the model learned how to distinguish good and bad results.

The validated model was then further tested on data gathered using other workflows to measure generalizability of the model. One test involved the independent testing of data gathered with across 16 pooled plasma samples processed using PROTEOGRAPH™ kits and analyzed using ThermoFisher Scientific ORBITRAP™ mass analyzer. Table 7 presents the independent test results for the trained model's precision, recall and F1 score for each class and its support value. The overall accuracy of the trained model was found to be 0.85.

TABLE 7
Standard test results

| | Precision | Recall | F1 score | Support |
|---|---|---|---|---|
| NP-1 | 0.93 | 0.88 | 0.90 | 16 |
| NP-3 | 0.70 | 1 | 0.82 | 16 |
| NP-4 | 1.00 | 0.94 | 0.97 | 16 |
| NP-5 | 0.92 | 0.75 | 0.83 | 16 |
| NP-6 | 0.79 | 0.69 | 0.73 | 16 |
| Accuracy | | | 0.85 | 80 |
| Macro average | 0.87 | 0.85 | 0.85 | 80 |
| Weighted | 0.87 | 0.85 | 0.85 | 80 |
| average | | | | |

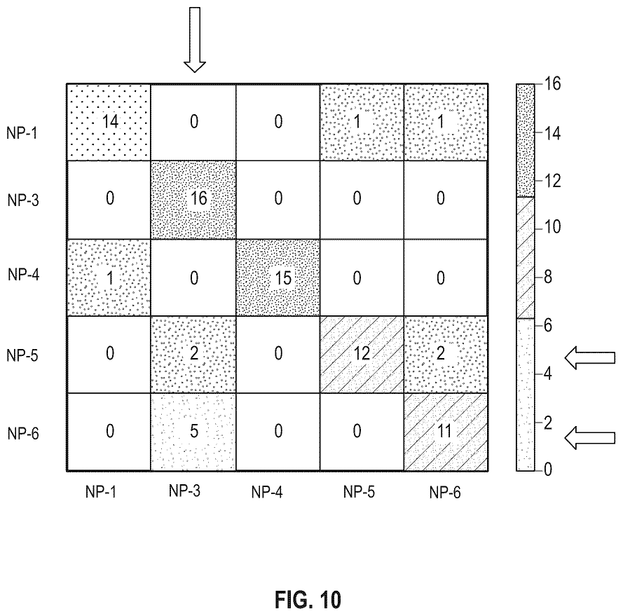

FIG. 10 depicts the accuracy matrix for the independent testing of a PC4 Orbi-2 v1.2 standard experiment. In this test 68 of 80 test samples were correctly classified. 12 test samples were incorrectly classified.

A stress test experiment was then performed to assess the model's ability to distinguish sample types (classes) from pooled plasma processed with PROTEOGRAPH™ kits as provided above and acquired on an EXPLORIS™ mass analyzer+a neat class (no nanoparticle). The use of these sample types and an additional “neat” class allowed for further assessment of the generalization of the model to different samples and preparation workflows. Table 8 presents the independent test results for the trained model's precision, Recall and F1 score for each class and its support value.

TABLE 8
Exploris-3 PC5 v1.2 standard test results

| | Precision | Recall | F1 score | Support |
|---|---|---|---|---|
| NP-1 | 0.67 | 1 | 0.8 | 4 |
| NP-3 | 1 | 1 | 1 | 4 |
| NP-4 | 1 | 0.5 | 0.67 | 4 |
| NP-5 | 0.5 | 1 | 0.67 | 4 |
| NP-6 | 1 | 1 | 1 | 4 |
| Accuracy | | | 0.75 | 24 |
| Macro average | 0.69 | .75 | .69 | 24 |
| Weighted | 0.69 | .75 | .69 | 24 |
| average | | | | |

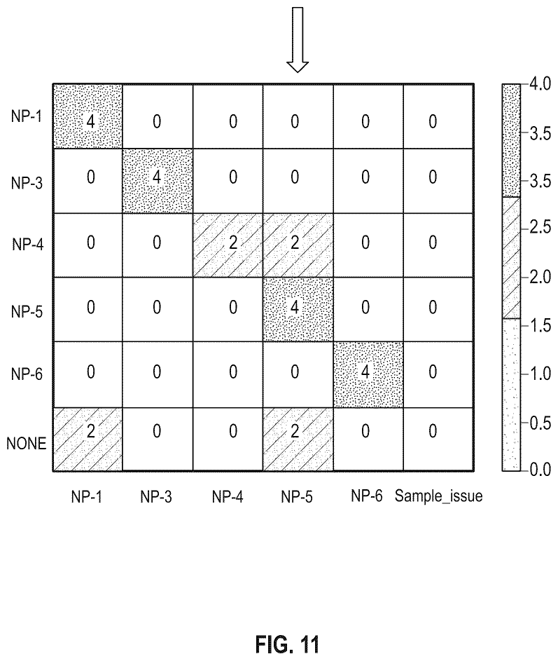

The overall accuracy of the model was found to be 0.75. However, when the NONE (neat, no nanoparticle) class was removed the accuracy improved to 0.9. Overall, the accuracy matrix of FIG. 11 shows 18 of 20 test samples were correctly classified. 2 test samples belonging to the NP-4 sample type class were incorrectly classified as sample type class NP-5. For two runs, the neat (no nanoparticle) class was incorrectly classified as the NP-1 sample class. And, for two runs, the neat class was incorrectly classified as the NP-5 sample class. None of NONE were properly classified as the sample_issue class.

A second stress test experiment covered independent testing sample types (classes) from a separate experiment. Table 9 presents the independent test results for the trained model's precision, Recall, and F1 score for each class and its support value.

TABLE 9
Second stress test results

| | Precision | Recall | F1 score | Support |
|---|---|---|---|---|
| NP-1 | 0 | 0.00 | 0.00 | 0 |
| NP-3 | 0.64 | 0.28 | 0.39 | 32 |
| NP-4 | 0.50 | 0.12 | 0.20 | 16 |
| NP-5 | 0.00 | 0.00 | 0.00 | 0 |
| NP-6 | 0.12 | 0.09 | 0.11 | 32 |
| Accuracy | | | 0.17 | 80 |
| Macro average | 0.25 | 0.10 | 0.14 | 80 |
| Weighted | 0.41 | 0.17 | 0.24 | 80 |
| average | | | | |

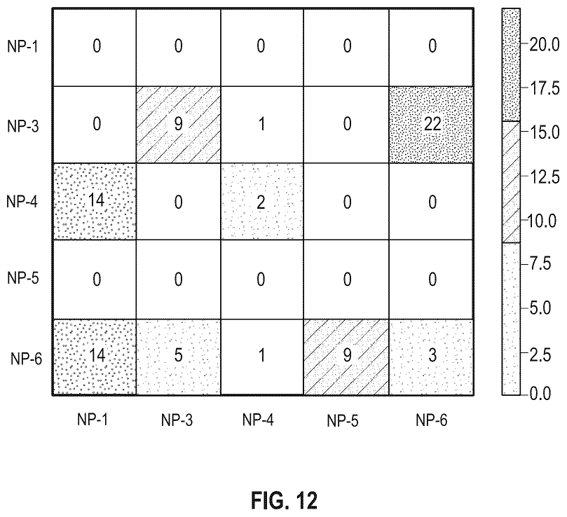

As can be seen in Table 6, the accuracy per the F1 score was 0.17. FIG. 12 depicts the classification accuracy matrix showing the results of 80 test samples across the five sample type classes. As this was a stress test, the correlation and accuracy were low.

A third stress test experiment covered testing independent sample types (classes) from a TimsTOF workflow. Table 10 presents the independent test results for the trained model's precision, Recall, and F1 score for each class and its support value.

TABLE 10
TimsTOF test results

| | Precision | Recall | F1 score | Support |
|---|---|---|---|---|
| NP-1 | 0.00 | 0.00 | 0.00 | 16 |
| NP-3 | 1.00 | 0.06 | 0.12 | 16 |
| NP-4 | 0.00 | 0.00 | 0.00 | 15 |
| NP-5 | 0.23 | 1.00 | 0.37 | 16 |
| NP-6 | 0.00 | 0.00 | 0.00 | 16 |
| Sample_issue | 0.00 | 0.00 | 0.00 | 0 |
| Accuracy | | | 0.22 | 79 |
| Macro average | 0.2 | 0.18 | 0.08 | 79 |
| Weighted average | 0.25 | 0.22 | 0.10 | 79 |

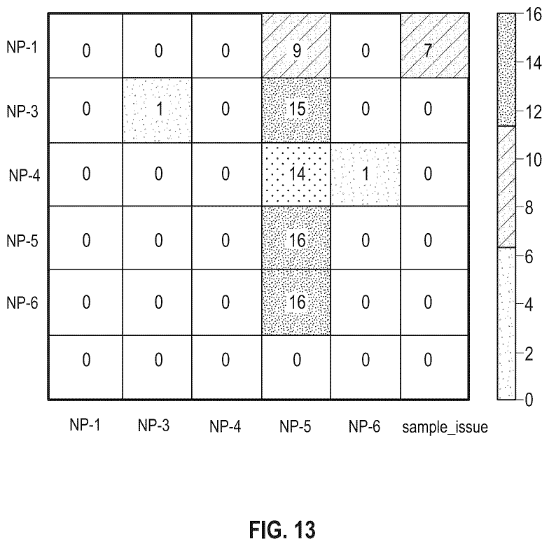

As can be seen in Table 10, the accuracy per the F1 score was 0.22. FIG. 13 depicts the classification accuracy matrix showing the results of 79 test samples across the five sample type classes. As this was a stress test, the correlation and accuracy were low.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

1. A neural network for identifying potential operational errors in mass spectrometry measurements, comprising:
(a) a first layer that receives a mass spectrum; and
(b) a second layer, in operable communication with the first layer, that outputs a classification for an experimental parameter, among a plurality of measurement types, that was used to generate the mass spectrum.

2. (canceled)

3. (canceled)

4. The neural network of claim 1, wherein the experimental parameter comprises a surface type, a sample type, a liquid chromatography (LC) column type, an LC system pressure, a mass ionizer type, a buffer type, a pH, a temperature, a contamination, a subject characteristic, or any combination thereof.

5. The neural network of claim 4, wherein the mass spectrum is generated from at least a part of a biological sample, wherein the experimental parameter comprises the subject characteristic, and wherein the subject characteristic comprises a characteristic associated with a subject from which the sample is derived.

6. (canceled)

7. The neural network of claim 4, wherein the experimental parameter comprises the surface type, and wherein the surface type comprises a particle type.

8. (canceled)

9. (canceled)

10. (canceled)

11. (canceled)

12. The neural network of claim 1, wherein the mass spectrum is generated from biomolecules enriched using surface-adsorption.

13. (canceled)

14. (canceled)

15. The neural network of claim 4, wherein the biological sample comprises plasma or serum.

16. The neural network of claim 15, wherein the biological sample comprises proteins.

17. The neural network of claim 1, wherein the mass spectrum is generated from tandem liquid chromatography-mass spectrometry (LC-MS/MS).

18. The neural network of claim 17, wherein the mass spectrum comprises an MS1 spectrum of the LC-MS/MS.

19. The neural network of claim 18, wherein the mass spectrum comprises an MS2 spectrum of the LC-MS/MS.

20. The neural network of claim 1, wherein the mass spectrum comprises a mass spectrum from sequential mass spectrometry (MSⁿ).

21. The neural network of claim 20, wherein the sequential mass spectrometry is tandem liquid chromatography-sequential mass spectrometry (LC-MSⁿ).

22. The neural network of claim 21, wherein n equals at least 3, 4, 5, 6, 7, 8, 9, or 10.

23. The neural network of claim 1, wherein the mass spectrum is provided to the first layer as an image map.

24. The neural network of claim 23, wherein the image map is subjected to one or more image processing operations.

25. The neural network of claim 24, wherein the image processing operation comprises an image compression operation, an image filtering operation, an object detection operation, an image concatenation operation, an image segmentation operation, an image downsampling operation, or any combination thereof.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. A method for identifying potential operational errors in mass spectrometry measurements, comprising:
(a) contacting a plurality of biomolecules with a first surface and a second surface to adsorb the plurality of biomolecules thereon;
(b) desorbing the plurality of biomolecules from (i) the first surface to generate a first sample, and (ii) the second surface to generate a second sample;
(c) performing mass spectrometry using (i) the first sample to generate a first mass spectrum, and (ii) the second sample to generate a second mass spectrum; and
(d) determining, using a neural network, whether the first mass spectrum is associated with signals from biomolecules desorbed from the first surface or the second surface, wherein a potential operational error exists when the first mass spectrum is not associated with signals from biomolecules desorbed from the first surface.

41. The method of claim 40, further comprising repeating (d) with one or more additional neural networks to provide a plurality of determinations and determining the potential operational error exists based on the plurality of determinations.

42. (canceled)

43. (canceled)

44. A method for obtaining the neural network of claim 1, the method comprising:
(a) providing a dataset comprising a plurality of mass spectra, wherein a first subset of the mass spectra is labeled with an anomaly indicator and a second subset of the mass spectra is not labeled with an anomaly indicator;
(b) training a neural network, on a training subset of the dataset, to distinguish between the first subset and the second subset; and
(c) testing the neural network on a holdout subset of the dataset to relabel a third subset of mass spectra in the plurality of mass spectra, thereby recategorizing a portion of (i) the first subset as non-anomalous, (ii) the second subset as anomalous, or (iii) both.

45. (canceled)

46. (canceled)

47. (canceled)

48. A computer-implemented system for identifying potential operational errors in mass spectrometry measurements on a cloud platform, comprising:
at least one digital processing device comprising at least one processor, an operating system configured to perform executable instructions, a computer memory, and a computer program including instructions that, upon execution by the at least one processor, cause the at least one processor to perform operations including:
(i) receiving experimental parameter data for a set of biological samples;
(ii) receiving mass spectrometry data characterizing the set of biological samples;
(iii) instantiating a serverless cloud computing instance;
(iv) analyzing the mass spectrometry data using the serverless cloud computing instance, wherein the analyzing comprises associating, with the aid of a neural network, the mass spectrometry data with one or more experimental parameters; and
(v) identifying samples with the experimental parameter data inconsistent with a neural network association.

49. (canceled)

50. (canceled)

51. (canceled)

52. (canceled)

53. (canceled)

54. (canceled)

55. (canceled)

56. (canceled)
